(19) United States
(12) Patent Application Publication
(10) Pub. No.: US 2026/0351012 A1
(43) Pub. Date: Nov. 5, 2026

(54) MULTI-MODAL FOUNDATIONAL MODEL AND WORLD MODEL BASED END-TO-END VEHICLE ARCHITECTURE

(71) Applicant: QUALCOMM Incorporated, San Diego, CA (US)

(72) Inventors: Varun RAVI KUMAR, San Diego, CA (US); Kiran BANGALORE RAVI, Paris (FR); Senthil Kumar YOGAMANI, San Diego, CA (US)

(21) Appl. No.: 19/652,947

(22) Filed: Apr. 20, 2026

Related U.S. Application Data
(60) Provisional application No. 63/796,962, filed on Apr. 29, 2025.

(51) Int. Cl. G06V 20/56; G06V 10/80; G06V 10/82; G06V 20/58

(52) U.S. Cl. CPC G06V 20/588; G06V 10/811; G06V 10/82; G06V 20/58

(57) ABSTRACT

Systems and techniques are described herein for a unified scene representation of an environment of a vehicle. For example, a computing device can receive, from a plurality of sensors of the vehicle, sensor data representative of the environment; process the sensor data from the plurality of sensors using a plurality of encoders to generate a plurality of outputs; generate, based on the plurality of outputs of the plurality of encoders, a plurality of world model tokens representing a unified scene representation of the environment; and decode the plurality of world model tokens using a plurality of perception decoders for performing at least one task.

### CROSS-REFERENCE TO RELATED APPLICATION

This application is a continuation of U.S. Patent Application No. 63/796,962, filed Apr. 29, 2025, which is incorporated by reference herein in its entirety.

### TECHNICAL FIELD

The present disclosure is generally related to autonomous vehicle driving. For example, aspects of the present disclosure relate to a multi-modal foundation model (FoMo) and world model (WoMo) based an end-to-end (E2E) architecture for vehicle operations (e.g., for autonomous driving operations, such as for mapping, trajectory planning, perception based operations such as object detection, etc.).

### BACKGROUND

Autonomous driving vehicle systems demand an integrated system capable of handling multiple tasks, such as perception, mapping, trajectory planning, etc., under a diverse set of sensor modalities (e.g., cameras, light detection and ranging (LIDAR), radio detection and ranging (RADAR), high definition (HD) maps, odometry, etc.). Traditional pipelines often split these tasks into separate modules, introducing fragile handoffs and the risk of error compounding.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In some aspects, an apparatus for processing sensor data is provided. The apparatus includes at least one memory and at least one processor coupled to the at memory and configured to: receive, from a plurality of sensors of a vehicle, sensor data representative of an environment; process the sensor data from the plurality of sensors using a plurality of encoders to generate a plurality of outputs; generate, based on the plurality of outputs of the plurality of encoders, a plurality of world model tokens representing a unified scene representation of the environment; and decode the plurality of world model tokens using a plurality of perception decoders for performing at least one task.

In some aspects, a method of processing sensor data is provided. The method includes: receiving, from a plurality of sensors of a vehicle, sensor data representative of an environment; processing the sensor data from the plurality of sensors using a plurality of encoders to generate a plurality of outputs; generating, based on the plurality of outputs of the plurality of encoders, a plurality of world model tokens representing a unified scene representation of the environment; and decoding the plurality of world model tokens using a plurality of perception decoders for performing at least one task.

In some aspects, a non-transitory computer-readable medium is provided that has stored thereon instructions that, when executed by one or more processors, cause the one or more processors to: receive, from a plurality of sensors of a vehicle, sensor data representative of an environment; process the sensor data from the plurality of sensors using a plurality of encoders to generate a plurality of outputs; generate, based on the plurality of outputs of the plurality of encoders, a plurality of world model tokens representing a unified scene representation of the environment; and decode the plurality of world model tokens using a plurality of perception decoders for performing at least one task.

In some aspects, an apparatus for processing sensor data is provided. The apparatus includes: means for receiving, from a plurality of sensors of a vehicle, sensor data representative of an environment; means for processing the sensor data from the plurality of sensors using a plurality of encoders to generate a plurality of outputs; means for generating, based on the plurality of outputs of the plurality of encoders, a plurality of world model tokens representing a unified scene representation of the environment; and means for decoding the plurality of world model tokens using a plurality of perception decoders for performing at least one task.

In some aspects, each of the apparatuses described herein is, can be part of, or can include a vehicle or computing system or component of the vehicle. In some aspects, the apparatus(es) can include one or more sensors, such as one or more image sensors (e.g., camera(s)) for capturing one or more images, one or more light detection and ranging (LIDAR) sensors for capturing LIDAR data, one or more radio detection and ranging (RADAR) sensors for capturing RADAR data, etc. In some cases, the one or more sensors can include sensor(s) used for determining a location of the apparatuses, a state of the apparatuses (e.g., a tracking state, an operating state, a temperature, a humidity level, and/or other state), and/or for other purposes. In some aspects, the apparatus(es) can include one or more displays for displaying one or more images, notifications, and/or other displayable data. In some aspects, the apparatus(es) can include one or more speakers, one or more light-emitting devices, and/or one or more microphones.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims. The foregoing, together with other features and aspects, will become more apparent upon referring to the following specification, claims, and accompanying drawings.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The preceding, together with other features and aspects, will become more apparent upon referring to the following specification, claims, and accompanying drawings.

### BRIEF DESCRIPTION OF THE DRAWINGS

Illustrative aspects of the present application are described in detail below with reference to the following figures:

FIGS. 1A and 1B are block diagrams illustrating a vehicle suitable for implementing various techniques described herein, in accordance with aspects of the present disclosure;

FIG. 1C is a block diagram illustrating components of a vehicle suitable for implementing various techniques described herein, in accordance with aspects of the present disclosure;

FIG. 1D illustrates an example implementation of a system-on-a-chip (SOC), in accordance with some examples;

FIG. 2A is a component block diagram illustrating components of an example vehicle management system, in accordance with aspects of the present disclosure;

FIG. 2B is a component block diagram illustrating components of another example vehicle management system, in accordance with aspects of the present disclosure;

FIG. 3A-FIG. 4B are diagrams illustrating examples of neural networks, in accordance with aspects of the present disclosure;

FIG. 5 is a diagram illustrating an example of a system for processing images for use by a device, in accordance with aspects of the present disclosure;

FIG. 6 illustrates an example of an End-to-End pipeline for processing sensor data from a plurality of sensors, in accordance with aspects of the present disclosure;

FIG. 7 is a diagram of a particular implementation of a method of processing audio based on sound source representations, in accordance with some examples of the present disclosure; and

FIG. 8 illustrates an example computing device architecture of an example computing device which can implement techniques described herein.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein can be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Vehicle systems can process data from sensors to perform various operations. For example, an autonomous vehicle system can process sensor data from various sensors (e.g., cameras, LIDAR sensors, RADAR sensors, etc.) using different pipelines in which different modules process the sensor data. Use of such different pipelines requires fragile handoff between the modules and can result compounding of errors across the modules.

Various aspects described herein relate to systems, apparatuses, electronic devices, methods (also referred to as processes), and computer-readable media (collectively referred to herein as “systems and techniques”) for processing data from various modalities and/or sensors (e.g., cameras, RADAR sensors, LIDAR sensors, high definition (HD) maps, odometry, etc.) using a single end-to-end (E2E) vehicle system framework. The single E2E vehicle system framework described hereins can simultaneously fuse multi-modal sensor data including, but not limited to, raw images, LIDAR returns (e.g., sensor data from one or more LIDAR sensors), RADAR returns (e.g., sensor data from one or more RADAR sensors), map polylines (e.g., from one or more HD maps), ego odometry, etc., in a tokenized format, and thereby preserving critical details without resorting to dense or siloed representations.

The E2E framework can also combine perception and mapping outputs such as dynamic object detection, occupancy estimation, lane boundaries, etc., into a consistent scene model that can be updated over time. The E2E framework can account for agent dynamics and static road constraints in a single representation, thereby enabling robust tracking of moving objects as well as accurate handling of road geometry. In some cases, the E2E framework can incorporate data-driven and rule-based reasoning for critical decision making, and thereby ensuring that complex traffic scenarios, such as merging, unprotected turns, etc., can be navigated safely. The E2E framework can produce a final driving plan (or trajectory or control signals) with minimal stage-wise dependencies in order to reduce error propagation and enhance overall performance.

Accordingly, the E2E framework, according to aspects described herein, develops a single-stage, end-to-end neural architecture that tokenizes all sensor inputs, builds a unified spatio-temporal world model, and plans the ego trajectory in a logically consistent way. By aligning all tasks under one jointly trained Transformer-based design, the disclosed E2E framework aims to improve performance and stability compared to multi-module pipelines, allow for flexible sensor suite expansion or modifications, and seamlessly integrate rule-based or textual knowledge (Chain-of-Thought) to handle complex driving maneuvers and traffic regulations.

In the present disclosure,

$${\{ {I}_{c} \}}_{c = 1}^{{N}_{c}}$$

refers to images from N_{c} cameras, and

$${\{ {R}_{r} \}}_{r = 1}^{{N}_{r}}$$

refers to RADAR inputs or RADAR feature maps, L refers to LIDAR points or LIDAR-based feature maps, H refers to HD-map features such as lane polylines, vector segments, traffic signs, etc. Further, 0 refers to odometry or INS data providing ego pose, velocity, etc. X_{ego} represents an ego state such as position, orientation, velocity, etc. Z_{FoMo} represents FoMo-encoded feature embeddings from multi-modal foundational model (FoMo) encoders, and Z_{WoMo} represents World Model (WoMo) tokens that capture spatio-temporal context. Z_{Agent}, Z_{Static}, etc., represent task-specific tokens for dynamic objects, static objects, road occupancy, etc. Z_{EM} represents environment mapping tokens representing the agent tracks or map states, and Z_{Plan} represents planning tokens for final trajectory prediction.

Particular aspects of the present disclosure are described below with reference to the drawings. In the description, common features are designated by common reference numbers. As used herein, various terminology is used for the purpose of describing particular implementations only and is not intended to be limiting of implementations. For example, the singular forms “a,” “an,” and “the” are intended to include the plural forms as well, unless the context clearly indicates otherwise. Further, some features described herein are singular in some implementations and plural in other implementations.

As used herein, a high definition (HD) map is a map that can be used by vehicles (e.g., autonomous and/or semi-autonomous vehicles) for various purposes, including navigation, scene understanding, etc. For instance, an HD map encodes prior knowledge of scenes (e.g., environment) that a vehicle may encounter. An HD map may be three-dimensional (e.g., including elevation information). For instance, an HD map may include three-dimensional data (e.g., elevation data) regarding a three-dimensional space, such as a road on which a vehicle is navigating. In some examples, the HD map can include a plurality of map points corresponding to one or more reference locations in the three-dimensional space. In some cases, the HD map can include dimensional information for objects in the three-dimensional space and other semantic information associated with the three-dimensional space. For instance, the information from the HD map can include elevation or height information (e.g., road elevation/height), normal information (e.g., road normal), and/or other semantic information related to a portion (e.g., the road) of the three-dimensional space in which the vehicle is navigating.

An HD map may include a high level of detail (e.g., including centimeter level details). In the context of HD maps, the term “high” typically refers to the level of detail and accuracy of the map data. In some cases, an HD map may have a higher spatial resolution and/or level of detail as compared to a non-HD map. While there is no specific universally accepted quantitative threshold to define “high” in HD maps, several factors contribute to the characterization of the quality and level of detail of an HD map. Some key aspects considered in evaluating the “high” quality of an HD map include resolution, geometric accuracy, semantic information, dynamic data, and coverage. With regard to resolution, HD maps generally have a high spatial resolution, meaning they provide detailed information about the environment. The resolution can be measured in terms of meters per pixel or pixels per meter, indicating the level of detail captured in the map. With regard to geometric accuracy, an accurate representation of road geometry, lane boundaries, and other features can be important in an HD map. High-quality HD maps strive for precise alignment and positioning of objects in the real world. Geometric accuracy is often quantified using metrics such as root mean square error (RMSE) or positional accuracy. With regard to semantic information, HD maps include not only geometric data but also semantic information about the environment. This may include lane-level information, traffic signs, traffic signals, road markings, building footprints, and more. The richness and completeness of the semantic information contribute to the level of detail in the map. With regard to dynamic data, some HD maps incorporate real-time or near real-time updates to capture dynamic elements such as traffic flow, road closures, construction zones, and temporary changes. The frequency and accuracy of dynamic updates can affect the quality of the HD map. With regard to coverage, the extent of coverage provided by an HD map is another important factor. Coverage refers to the geographical area covered by the map. An HD map can cover a significant portion of a city, region, or country. In general, an HD map may exhibit a rich level of detail, accurate representation of the environment, and extensive coverage.

For a vehicle (e.g., an autonomous or semi-autonomous vehicle) to utilize HD maps, the vehicle must determine its own position (location) in relation to the HD map. An autonomous vehicle typically utilizes positioning sensors implemented onboard the vehicle to estimate a location of the vehicle. These positioning sensors can include satellite receivers (e.g., for satellite positioning systems) and inertial measurement units (IMUs).

As used herein, the terms “comprise,” “comprises,” and “comprising” may be used interchangeably with “include,” “includes,” or “including.” Additionally, the term “wherein” may be used interchangeably with “where.” As used herein, “exemplary” indicates an example, an implementation, and/or an aspect, and should not be construed as limiting or as indicating a preference or a preferred implementation. As used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). As used herein, the term “set” refers to one or more of a particular element, and the term “plurality” refers to multiple (e.g., two or more) of a particular element.

As used herein, “coupled” may include “communicatively coupled,” “electrically coupled,” or “physically coupled,” and may also (or alternatively) include any combinations thereof. Two devices (or components) may be coupled (e.g., communicatively coupled, electrically coupled, or physically coupled) directly or indirectly via one or more other devices, components, wires, buses, networks (e.g., a wired network, a wireless network, or a combination thereof), etc. Two devices (or components) that are electrically coupled may be included in the same device or in different devices and may be connected via electronics, one or more connectors, or inductive coupling, as illustrative, non-limiting examples. In some implementations, two devices (or components) that are communicatively coupled, such as in electrical communication, may send and receive signals (e.g., digital signals or analog signals) directly or indirectly, via one or more wires, buses, networks, etc. As used herein, “directly coupled” may include two devices that are coupled (e.g., communicatively coupled, electrically coupled, or physically coupled) without intervening components.

In the present disclosure, terms such as “determining,” “calculating,” “estimating,” “shifting,” “adjusting,” etc. may be used to describe how one or more operations are performed. It should be noted that such terms are not to be construed as limiting and other techniques may be utilized to perform similar operations. Additionally, as referred to herein, “generating,” “calculating,” “estimating,” “using,” “selecting,” “accessing,” and “determining” may be used interchangeably. For example, “generating,” “calculating,” “estimating,” or “determining” a parameter (or a signal) may refer to actively generating, estimating, calculating, or determining the parameter (or the signal) or may refer to using, selecting, or accessing the parameter (or signal) that is already generated, such as by another component or device.

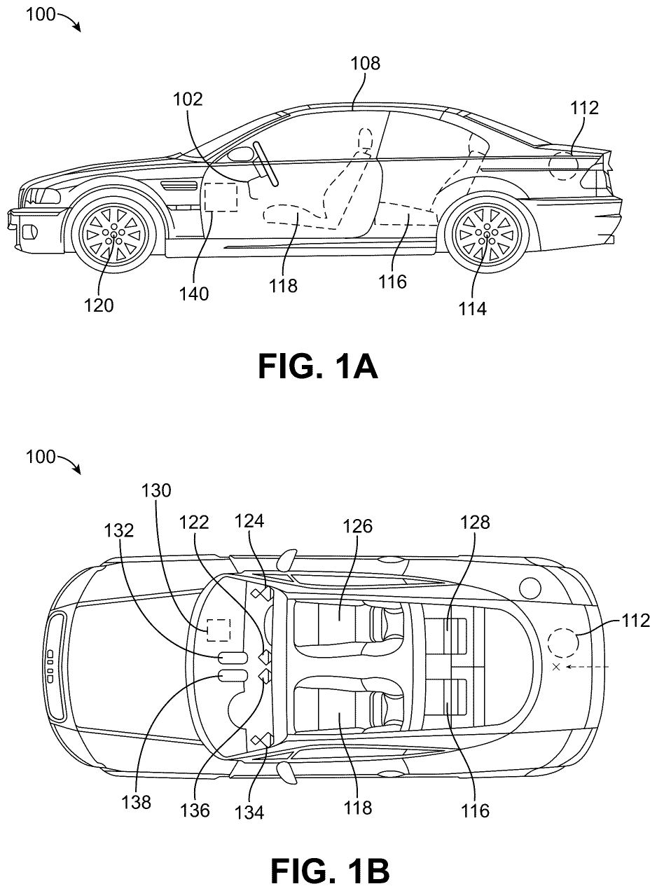

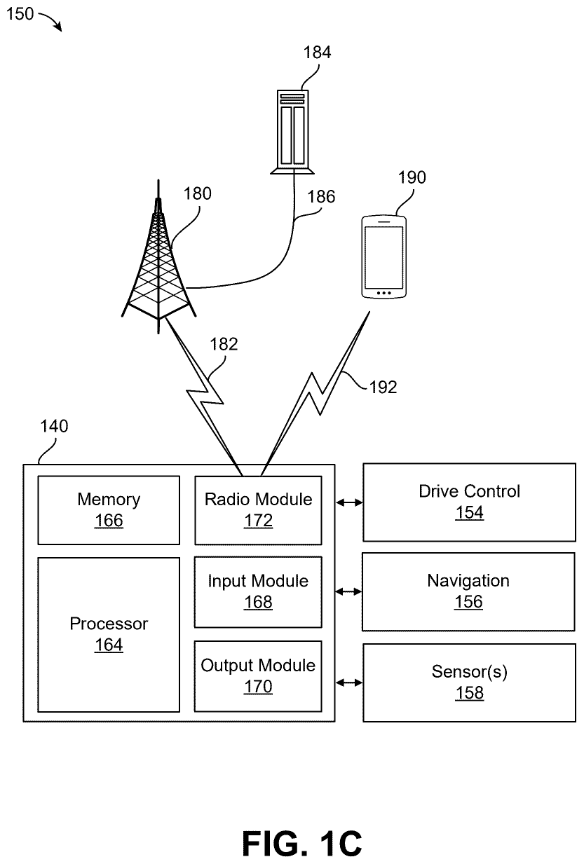

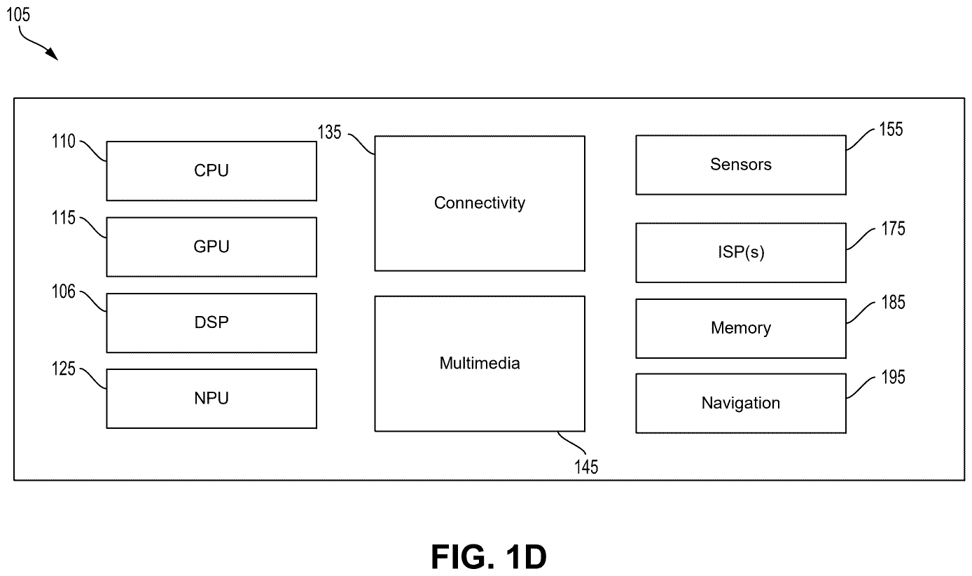

The systems and techniques described herein may be implemented by any type of system or device. One illustrative example of a system that can be used to implement the systems and techniques described herein is a vehicle (e.g., an autonomous or semi-autonomous vehicle) or a system or component (e.g., an ADAS or other system or component) of the vehicle. FIGS. 1A and 1B are diagrams illustrating an example vehicle 100 that may implement the systems and techniques described herein. With reference to FIGS. 1A and 1, a vehicle 100 may include a control unit 140 and a plurality of sensors 102-138, including satellite geopositioning system receivers (e.g., sensors) 108, occupancy sensors 112, 116, 118, 126, 128, tire pressure sensors 114, 120, cameras 122, 136, microphones 124, 134, impact sensors 130, RADAR 132, and LIDAR 138. The plurality of sensors 102-138, disposed in or on the vehicle, may be used for various purposes, such as autonomous and semi-autonomous navigation and control, crash avoidance, position determination, etc., as well to provide sensor data regarding objects and people in or on the vehicle 100. The sensors 102-138 may include one or more of a wide variety of sensors capable of detecting a variety of information useful for navigation and collision avoidance. Each of the sensors 102-138 may be in wired or wireless communication with a control unit 140, as well as with each other. In particular, the sensors may include one or more cameras 122, 136 or other optical sensors or photo optic sensors. The sensors may further include other types of object detection and ranging sensors, such as RADAR 132, LIDAR 138, IR sensors, and ultrasonic sensors. The sensors may further include tire pressure sensors 114, 120, humidity sensors, temperature sensors, satellite geopositioning sensors 108, accelerometers, vibration sensors, gyroscopes, gravimeters, impact sensors 130, force meters, stress meters, strain sensors, fluid sensors, chemical sensors, gas content analyzers, pH sensors, radiation sensors, Geiger counters, neutron detectors, biological material sensors, microphones 124, 134, occupancy sensors 112, 116, 118, 126, 128, proximity sensors, and other sensors.

The vehicle control unit 140 may be configured with processor-executable instructions to perform various aspects using information received from various sensors, particularly the cameras 122, 136, RADAR 132, and LIDAR 138. In some aspects, the control unit 140 may supplement the processing of camera images using distance and relative position information (e.g., relative bearing angle) that may be obtained from RADAR 132 and/or LIDAR 138 sensors. The control unit 140 may further be configured to control steering, breaking and speed of the vehicle 100 when operating in an autonomous or semi-autonomous mode using information regarding other vehicles determined using various aspects.

FIG. 1C is a component block diagram illustrating a system 150 of components and support systems suitable for implementing various aspects. With reference to FIGS. 1A, 1i, and 1C, a vehicle 100 may include a control unit 140, which may include various circuits and devices used to control the operation of the vehicle 100. In the example illustrated in FIG. 1C, the control unit 140 includes a processor 164, memory 166, an input module 168, an output module 170 and a radio module 172. The control unit 140 may be coupled to and configured to control drive control components 154, navigation components 156, and one or more sensors 158 of the vehicle 100.

The control unit 140 may include a processor 164 that may be configured with processor-executable instructions to control maneuvering, navigation, and/or other operations of the vehicle 100, including operations of various aspects. The processor 164 may be coupled to the memory 166. The control unit 140 may include the input module 168, the output module 170, and the radio module 172.

The radio module 172 may be configured for wireless communication. The radio module 172 may exchange signals 182 (e.g., command signals for controlling maneuvering, signals from navigation facilities, etc.) with a network node 180, and may provide the signals 182 to the processor 164 and/or the navigation components 156. In some aspects, the radio module 172 may enable the vehicle 100 to communicate with a wireless communication device 190 through a wireless communication link 192. The wireless communication link 92 may be a bidirectional or unidirectional communication link and may use one or more communication protocols.

The input module 168 may receive sensor data from one or more vehicle sensors 158 as well as electronic signals from other components, including the drive control components 154 and the navigation components 156. The output module 170 may be used to communicate with or activate various components of the vehicle 100, including the drive control components 154, the navigation components 156, and the sensor(s) 158.

The control unit 140 may be coupled to the drive control components 154 to control physical elements of the vehicle 100 related to maneuvering and navigation of the vehicle, such as the engine, motors, throttles, steering elements, other control elements, braking or deceleration elements, and the like. The drive control components 154 may also include components that control other devices of the vehicle, including environmental controls (e.g., air conditioning and heating), external and/or interior lighting, interior and/or exterior informational displays (which may include a display screen or other devices to display information), safety devices (e.g., haptic devices, audible alarms, etc.), and other similar devices.

The control unit 140 may be coupled to the navigation components 156 and may receive data from the navigation components 156. The control unit 140 may be configured to use such data to determine the present position and orientation of the vehicle 100, as well as an appropriate course toward a destination. In various aspects, the navigation components 156 may include or be coupled to a global navigation satellite system (GNSS) receiver system (e.g., one or more Global Positioning System (GPS) receivers) enabling the vehicle 100 to determine its current position using GNSS signals. Alternatively, or in addition, the navigation components 156 may include radio navigation receivers for receiving navigation beacons or other signals from radio nodes, such as Wi-Fi access points, cellular network sites, radio station, remote computing devices, other vehicles, etc. Through control of the drive control components 154, the processor 164 may control the vehicle 100 to navigate and maneuver. The processor 164 and/or the navigation components 156 may be configured to communicate with a server 184 on a network 186 (e.g., the Internet) using wireless signals 182 exchanged over a cellular data network via network node 180 to receive commands to control maneuvering, receive data useful in navigation, provide real-time position reports, and assess other data.

The control unit 140 may be coupled to one or more sensors 158. The sensor(s) 158 may include the sensors 102-138 as described, and may the configured to provide a variety of data to the processor 164.

While the control unit 140 is described as including separate components, in some aspects some or all of the components (e.g., the processor 164, the memory 166, the input module 168, the output module 170, and the radio module 172) may be integrated in a single device or module, such as a system-on-chip (SOC) processing device. Such an SOC processing device may be configured for use in vehicles and be configured, such as with processor-executable instructions executing in the processor 164, to perform operations of various aspects when installed into a vehicle.

FIG. 1D illustrates an example implementation of a system-on-a-chip (SOC) 105, which may include a central processing unit (CPU) 110 or a multi-core CPU, configured to perform one or more of the functions described herein. In some cases, the SOC 105 may be based on an ARM instruction set. In some cases, CPU 110 may be similar to processor 164. Parameters or variables (e.g., neural signals and synaptic weights), system parameters associated with a computational device (e.g., neural network with weights), delays, frequency bin information, task information, among other information may be stored in a memory block associated with a neural processing unit (NPU) 125, in a memory block associated with a CPU 110, in a memory block associated with a graphics processing unit (GPU) 115, in a memory block associated with a digital signal processor (DSP) 106, in a memory block 185, and/or may be distributed across multiple blocks. Instructions executed at the CPU 110 may be loaded from a program memory associated with the CPU 110 or may be loaded from a memory block 185.

The SOC 105 may also include additional processing blocks tailored to specific functions, such as a GPU 115, a DSP 106, a connectivity block 135, which may include fifth generation (5G) connectivity, fourth generation long term evolution (4G LTE) connectivity, Wi-Fi connectivity, USB connectivity, Bluetooth connectivity, and the like, and a multimedia processor 145 that may, for example, detect and recognize gestures. In one implementation, the NPU is implemented in the CPU 110, DSP 106, and/or GPU 115. The SOC 105 may also include a sensor processor 155, image signal processors (ISPs) 175, and/or navigation module 195, which may include a global positioning system. In some cases, the navigation module 195 may be similar to navigation components 156 and sensor processor 155 may accept input from, for example, one or more sensors 158. In some cases, the connectivity block 135 may be similar to the radio module 172.

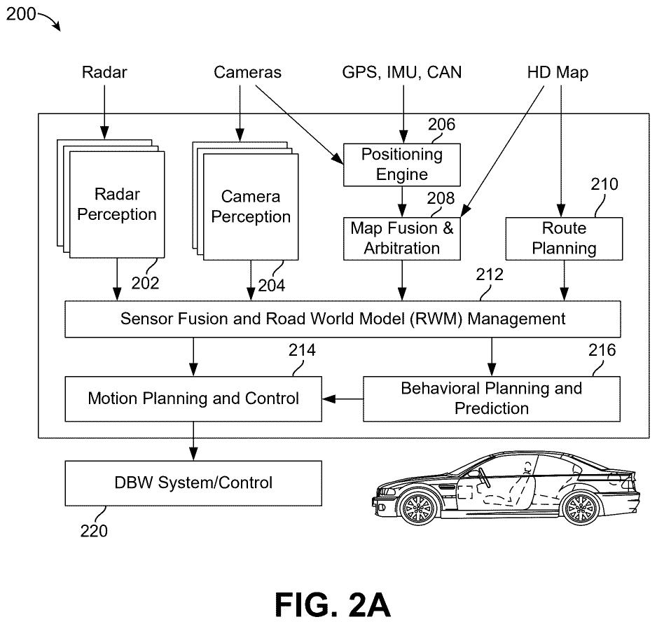

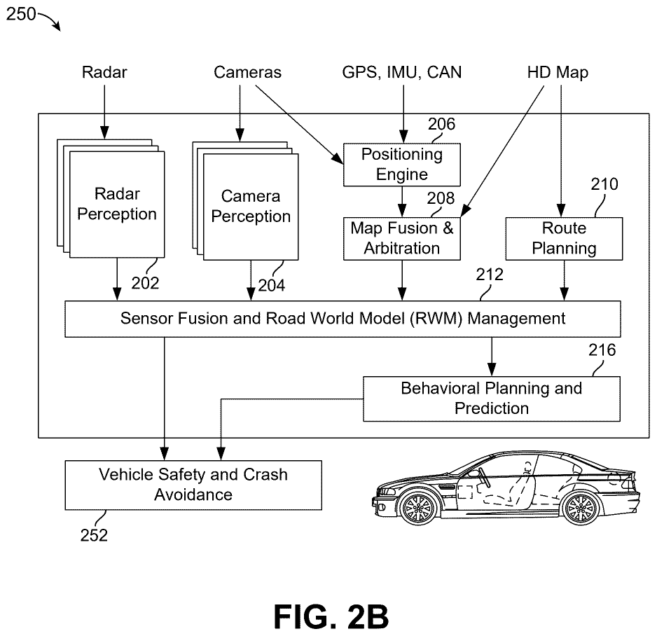

FIG. 2A illustrates an example of vehicle applications, subsystems, computational elements, or units within a vehicle management system 200, which may be utilized within a vehicle, such as vehicle 100 of FIG. 1A. With reference to FIGS. 1A-2A, in some aspects, the various vehicle applications, computational elements, or units within vehicle management system 200 may be implemented within a system of interconnected computing devices (i.e., subsystems), that communicate data and commands to each other. In other aspects, the vehicle management system 200 may be implemented as a plurality of vehicle applications executing within a single computing device, such as separate threads, processes, algorithms or computational elements. However, the use of the term vehicle applications in describing various aspects are not intended to imply or require that the corresponding functionality is implemented within a single autonomous (or semi-autonomous) vehicle management system computing device, although that is a potential implementation aspect. Rather the use of the term vehicle applications is intended to encompass subsystems with independent processors, computational elements (e.g., threads, algorithms, subroutines, etc.) running in one or more computing devices, and combinations of subsystems and computational elements.

In various aspects, the vehicle applications executing in a vehicle management system 200 may include (but is not limited to) a RADAR perception vehicle application 202, a camera perception vehicle application 204, a positioning engine vehicle application 206, a map fusion and arbitration vehicle application 208, a route vehicle planning application 210, sensor fusion and road world model (RWM) management vehicle application 212, motion planning and control vehicle application 214, and behavioral planning and prediction vehicle application 216. The vehicle applications 202-216 are merely examples of some vehicle applications in one example configuration of the vehicle management system 200. In other configurations consistent with various aspects, other vehicle applications may be included, such as additional vehicle applications for other perception sensors (e.g., LIDAR perception layer, etc.), additional vehicle applications for planning and/or control, additional vehicle applications for modeling, etc., and/or certain of the vehicle applications 202-216 may be excluded from the vehicle management system 200. Each of the vehicle applications 202-216 may exchange data, computational results and commands.

The vehicle management system 200 may receive and process data from sensors (e.g., RADAR, LIDAR, cameras, inertial measurement units (IMU) etc.), navigation systems (e.g., GPS receivers, IMUs, etc.), vehicle networks (e.g., Controller Area Network (CAN) bus), and databases in memory (e.g., digital map data). The vehicle management system 200 may output vehicle control commands or signals to the drive by wire (DBW) system/control unit 220, which is a system, subsystem or computing device that interfaces directly with vehicle steering, throttle and brake controls. The configuration of the vehicle management system 200 and DBW system/control unit 220 illustrated in FIG. 2A is merely an example configuration and other configurations of a vehicle management system and other vehicle components may be used in the various aspects. As an example, the configuration of the vehicle management system 200 and DBW system/control unit 220 illustrated in FIG. 2A may be used in a vehicle configured for autonomous or semi-autonomous operation while a different configuration may be used in a non-autonomous vehicle.

The RADAR perception vehicle application 202 may receive data from one or more detection and ranging sensors, such as radar (e.g., RADAR 132) and/or LIDAR (e.g., LIDAR 138) and process the data to recognize and determine locations of other vehicles and objects within a vicinity of the vehicle 100. The RADAR perception vehicle application 202 may include the use of neural network processing and artificial intelligence methods to recognize objects and vehicles and pass such information on to the sensor fusion and RWM management vehicle application 212.

The camera perception vehicle application 204 may receive data from one or more cameras, such as cameras (e.g., cameras 122, 136) and process the data to recognize and determine locations of other vehicles and objects within a vicinity of the vehicle 100. The camera perception vehicle application 204 may include use of neural network processing and artificial intelligence methods to recognize objects and vehicles and pass such information on to the sensor fusion and RWM management vehicle application 212.

The positioning engine vehicle application 206 may receive data from various sensors and process the data to determine a position of the vehicle 100. The various sensors may include, but is not limited to, GPS sensor, an IMU, and/or other sensors connected via a CAN bus. The positioning engine vehicle application 206 may also utilize inputs from one or more cameras, such as cameras (e.g., cameras 122, 136) and/or any other available sensor, such as RADARs, LIDARs, etc.

The map fusion and arbitration vehicle application 208 may access data within a high-definition (HD) map database and receive output received from the positioning engine vehicle application 206 and process the data to further determine the position of the vehicle 100 within the map, such as location within a lane of traffic, position within a street map, etc. The HD map database may be stored in a memory (e.g., memory 166). For example, the map fusion and arbitration vehicle application 208 may convert latitude and longitude information from GPS into locations within a surface map of roads contained in the HD map database. GPS position fixes include errors, so the map fusion and arbitration vehicle application 208 may function to determine a best guess location of the vehicle 100 within a roadway based upon an arbitration between the GPS coordinates and the HD map data. For example, while GPS coordinates may place the vehicle 100 near the middle of a two-lane road in the HD map, the map fusion and arbitration vehicle application 208 may determine from the direction of travel that the vehicle 100 is most likely aligned with the travel lane consistent with the direction of travel. The map fusion and arbitration vehicle application 208 may pass map-based location information to the sensor fusion and RWM management vehicle application 212.

The route planning vehicle application 210 may utilize the HD map, as well as inputs from an operator or dispatcher to plan a route to be followed by the vehicle 100 to a particular destination. The route planning vehicle application 210 may pass map-based location information to the sensor fusion and RWM management vehicle application 212. However, the use of a prior map by other vehicle applications, such as the sensor fusion and RWM management vehicle application 212, etc., is not required. For example, other stacks may operate and/or control the vehicle based on perceptual data alone without a provided map, constructing lanes, boundaries, and the notion of a local map as perceptual data is received.

The sensor fusion and RWM management vehicle application 212 may receive data and outputs produced by one or more of the RADAR perception vehicle application 202, camera perception vehicle application 204, map fusion and arbitration vehicle application 208, and route planning vehicle application 210, and use some or all of such inputs to estimate or refine the location and state of the vehicle 100 in relation to the road, other vehicles on the road, and other objects within a vicinity of the vehicle 100. For example, the sensor fusion and RWM management vehicle application 212 may combine imagery data from the camera perception vehicle application 204 with arbitrated map location information from the map fusion and arbitration vehicle application 208 to refine the determined position of the vehicle within a lane of traffic. As another example, the sensor fusion and RWM management vehicle application 212 may combine object recognition and imagery data from the camera perception vehicle application 204 with object detection and ranging data from the RADAR perception vehicle application 202 to determine and refine the relative position of other vehicles and objects in the vicinity of the vehicle. As another example, the sensor fusion and RWM management vehicle application 212 may receive information from vehicle-to-vehicle (V2V) communications (such as via the CAN bus) regarding other vehicle positions and directions of travel and combine that information with information from the RADAR perception vehicle application 202 and the camera perception vehicle application 204 to refine the locations and motions of other vehicles. The sensor fusion and RWM management vehicle application 212 may output refined location and state information of the vehicle 100, as well as refined location and state information of other vehicles and objects in the vicinity of the vehicle, to the motion planning and control vehicle application 214 and/or the behavior planning and prediction vehicle application 216.

As a further example, the sensor fusion and RWM management vehicle application 212 may use dynamic traffic control instructions directing the vehicle 100 to change speed, lane, direction of travel, or other navigational element(s), and combine that information with other received information to determine refined location and state information. The sensor fusion and RWM management vehicle application 212 may output the refined location and state information of the vehicle 100, as well as refined location and state information of other vehicles and objects in the vicinity of the vehicle 100, to the motion planning and control vehicle application 214, the behavior planning and prediction vehicle application 216 and/or devices remote from the vehicle 100, such as a data server, other vehicles, etc., via wireless communications, such as through C-V2X connections, other wireless connections, etc.

As a still further example, the sensor fusion and RWM management vehicle application 212 may monitor perception data from various sensors, such as perception data from a RADAR perception vehicle application 202, camera perception vehicle application 204, other perception vehicle application, etc., and/or data from one or more sensors themselves to analyze conditions in the vehicle sensor data. The sensor fusion and RWM management vehicle application 212 may be configured to detect conditions in the sensor data, such as sensor measurements being at, above, or below a threshold, certain types of sensor measurements occurring, etc., and may output the sensor data as part of the refined location and state information of the vehicle 100 provided to the behavior planning and prediction vehicle application 216 and/or devices remote from the vehicle 100, such as a data server, other vehicles, etc., via wireless communications, such as through C-V2X connections, other wireless connections, etc.

The refined location and state information may include vehicle descriptors associated with the vehicle 100 and the vehicle owner and/or operator, such as: vehicle specifications (e.g., size, weight, color, on board sensor types, etc.); vehicle position, speed, acceleration, direction of travel, attitude, orientation, destination, fuel/power level(s), and other state information; vehicle emergency status (e.g., is the vehicle an emergency vehicle or private individual in an emergency); vehicle restrictions (e.g., heavy/wide load, turning restrictions, high occupancy vehicle (HOV) authorization, etc.); capabilities (e.g., all-wheel drive, four-wheel drive, snow tires, chains, connection types supported, on board sensor operating statuses, on board sensor resolution levels, etc.) of the vehicle; equipment problems (e.g., low tire pressure, weak breaks, sensor outages, etc.); owner/operator travel preferences (e.g., preferred lane, roads, routes, and/or destinations, preference to avoid tolls or highways, preference for the fastest route, etc.); permissions to provide sensor data to a data agency server (e.g., 184); and/or owner/operator identification information.

The behavioral planning and prediction vehicle application 216 of the autonomous vehicle system 200 may use the refined location and state information of the vehicle 100 and location and state information of other vehicles and objects output from the sensor fusion and RWM management vehicle application 212 to predict future behaviors of other vehicles and/or objects. For example, the behavioral planning and prediction vehicle application 216 may use such information to predict future relative positions of other vehicles in the vicinity of the vehicle based on own vehicle position and velocity and other vehicle positions and velocity. Such predictions may take into account information from the HD map and route planning to anticipate changes in relative vehicle positions as host and other vehicles follow the roadway. The behavioral planning and prediction vehicle application 216 may output other vehicle and object behavior and location predictions to the motion planning and control vehicle application 214.

Additionally, the behavior planning and prediction vehicle application 216 may use object behavior in combination with location predictions to plan and generate control signals for controlling the motion of the vehicle 100. For example, based on route planning information, refined location in the roadway information, and relative locations and motions of other vehicles, the behavior planning and prediction vehicle application 216 may determine that the vehicle 100 needs to change lanes and accelerate, such as to maintain or achieve minimum spacing from other vehicles, and/or prepare for a turn or exit. As a result, the behavior planning and prediction vehicle application 216 may calculate or otherwise determine a steering angle for the wheels and a change to the throttle setting to be commanded to the motion planning and control vehicle application 214 and DBW system/control unit 220 along with such various parameters necessary to effectuate such a lane change and acceleration. One such parameter may be a computed steering wheel command angle.

The motion planning and control vehicle application 214 may receive data and information outputs from the sensor fusion and RWM management vehicle application 212 and other vehicle and object behavior as well as location predictions from the behavior planning and prediction vehicle application 216, and use this information to plan and generate control signals for controlling the motion of the vehicle 100 and to verify that such control signals meet safety requirements for the vehicle 100. For example, based on route planning information, refined location in the roadway information, and relative locations and motions of other vehicles, the motion planning and control vehicle application 214 may verify and pass various control commands or instructions to the DBW system/control unit 220.

The DBW system/control unit 220 may receive the commands or instructions from the motion planning and control vehicle application 214 and translate such information into mechanical control signals for controlling wheel angle, brake and throttle of the vehicle 100. For example, DBW system/control unit 220 may respond to the computed steering wheel command angle by sending corresponding control signals to the steering wheel controller.

In various aspects, the vehicle management system 200 may include functionality that performs safety checks or oversight of various commands, planning or other decisions of various vehicle applications that could impact vehicle and occupant safety. Such safety check or oversight functionality may be implemented within a dedicated vehicle application or distributed among various vehicle applications and included as part of the functionality. In some aspects, a variety of safety parameters may be stored in memory and the safety checks or oversight functionality may compare a determined value (e.g., relative spacing to a nearby vehicle, distance from the roadway centerline, etc.) to corresponding safety parameter(s), and issue a warning or command if the safety parameter is or will be violated. For example, a safety or oversight function in the behavior planning and prediction vehicle application 216 (or in a separate vehicle application) may determine the current or future separate distance between another vehicle (as refined by the sensor fusion and RWM management vehicle application 212) and the vehicle 100 (e.g., based on the world model refined by the sensor fusion and RWM management vehicle application 212), compare that separation distance to a safe separation distance parameter stored in memory, and issue instructions to the motion planning and control vehicle application 214 to speed up, slow down or turn if the current or predicted separation distance violates the safe separation distance parameter. As another example, safety or oversight functionality in the motion planning and control vehicle application 214 (or a separate vehicle application) may compare a determined or commanded steering wheel command angle to a safe wheel angle limit or parameter and issue an override command and/or alarm in response to the commanded angle exceeding the safe wheel angle limit.

Some safety parameters stored in memory may be static (i.e., unchanging over time), such as maximum vehicle speed. Other safety parameters stored in memory may be dynamic in that the parameters are determined or updated continuously or periodically based on vehicle state information and/or environmental conditions. Non-limiting examples of safety parameters include maximum safe speed, maximum brake pressure, maximum acceleration, and the safe wheel angle limit, all of which may be a function of roadway and weather conditions.

FIG. 2B illustrates an example of vehicle applications, subsystems, computational elements, or units within a vehicle management system 250, which may be utilized within a vehicle 100. With reference to FIGS. 1A-2B, in some aspects, the vehicle applications 202, 204, 206, 208, 210, 212, and 216 of the vehicle management system 200 may be similar to those described with reference to FIG. 2A and the vehicle management system 250 may operate similar to the vehicle management system 200, except that the vehicle management system 250 may pass various data or instructions to a vehicle safety and crash avoidance system 252 rather than the DBW system/control unit 220. For example, the configuration of the vehicle management system 250 and the vehicle safety and crash avoidance system 252 illustrated in FIG. 2B may be used in a non-autonomous vehicle.

In various aspects, the behavioral planning and prediction vehicle application 216 and/or sensor fusion and RWM management vehicle application 212 may output data to the vehicle safety and crash avoidance system 252. For example, the sensor fusion and RWM management vehicle application 212 may output sensor data as part of refined location and state information of the vehicle 100 provided to the vehicle safety and crash avoidance system 252. The vehicle safety and crash avoidance system 252 may use the refined location and state information of the vehicle 100 to make safety determinations relative to the vehicle 100 and/or occupants of the vehicle 100. As another example, the behavioral planning and prediction vehicle application 216 may output behavior models and/or predictions related to the motion of other vehicles to the vehicle safety and crash avoidance system 252. The vehicle safety and crash avoidance system 252 may use the behavior models and/or predictions related to the motion of other vehicles to make safety determinations relative to the vehicle 100 and/or occupants of the vehicle 100.

In various aspects, the vehicle safety and crash avoidance system 252 may include functionality that performs safety checks or oversight of various commands, planning, or other decisions of various vehicle applications, as well as human driver actions, that could impact vehicle and occupant safety. In some aspects, a variety of safety parameters may be stored in memory and the vehicle safety and crash avoidance system 252 may compare a determined value (e.g., relative spacing to a nearby vehicle, distance from the roadway centerline, etc.) to corresponding safety parameter(s), and issue a warning or command if the safety parameter is or will be violated. For example, a vehicle safety and crash avoidance system 252 may determine the current or future separate distance between another vehicle (as refined by the sensor fusion and RWM management vehicle application 212) and the vehicle (e.g., based on the world model refined by the sensor fusion and RWM management vehicle application 212), compare that separation distance to a safe separation distance parameter stored in memory, and issue instructions to a driver to speed up, slow down or turn if the current or predicted separation distance violates the safe separation distance parameter. As another example, a vehicle safety and crash avoidance system 252 may compare a human driver's change in steering wheel angle to a safe wheel angle limit or parameter, and issue an override command and/or alarm in response to the steering wheel angle exceeding the safe wheel angle limit.

As indicated above, different modes of data received from different sensors may be fused into a single data modality which can provide more information about the environment than would be available from a single type of sensor. In some cases, one or more machine learning techniques may be used as a part of sensor fusion.

A neural network is an example of a machine learning system, and a neural network can include an input layer, one or more hidden layers, and an output layer. Data is provided from input nodes of the input layer, processing is performed by hidden nodes of the one or more hidden layers, and an output is produced through output nodes of the output layer. Deep learning networks typically include multiple hidden layers. Each layer of the neural network can include feature maps or activation maps that can include artificial neurons (or nodes). A feature map can include a filter, a kernel, or the like. The nodes can include one or more weights used to indicate an importance of the nodes of one or more of the layers. In some cases, a deep learning network can have a series of many hidden layers, with early layers being used to determine simple and low level characteristics of an input, and later layers building up a hierarchy of more complex and abstract characteristics.

A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases.

Deep learning architectures may perform especially well when applied to problems that have a natural hierarchical structure. For example, the classification of motorized vehicles may benefit from first learning to recognize wheels, windshields, and other features. These features may be combined at higher layers in different ways to recognize cars, trucks, and airplanes.

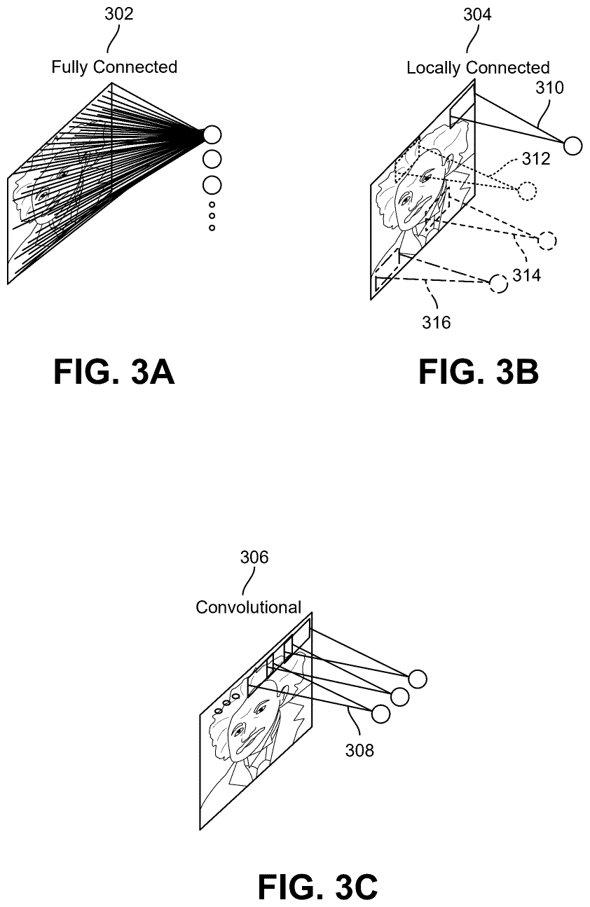

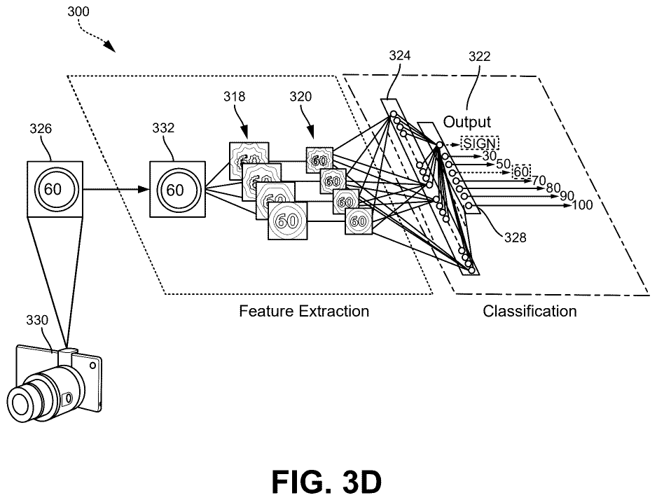

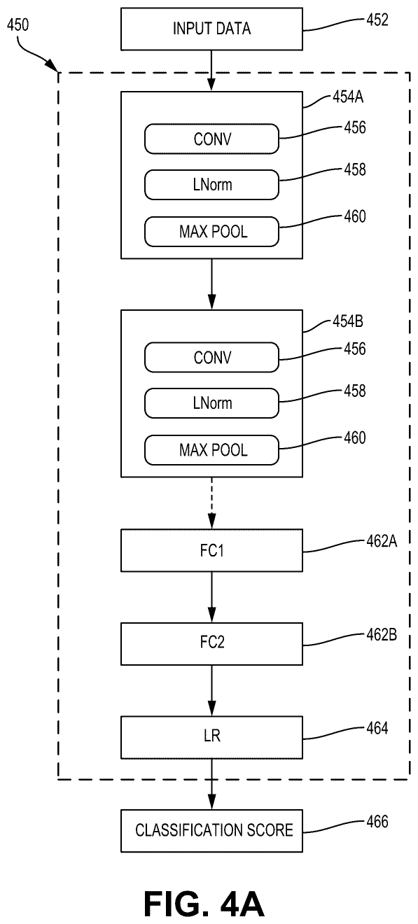

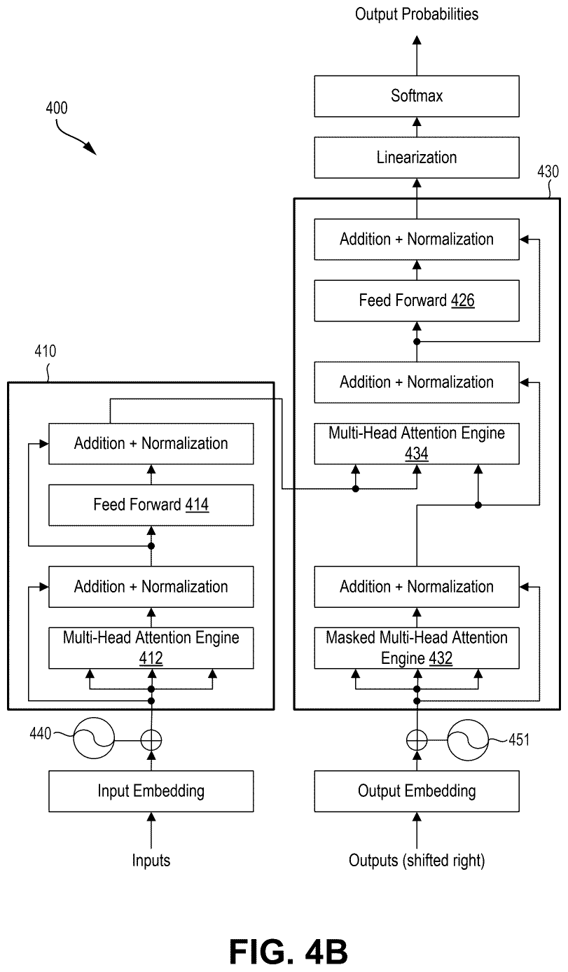

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input. The connections between layers of a neural network may be fully connected or locally connected. Various examples of neural network architectures are described below with respect to FIG. 3A-FIG. 4B.

Some sensor fusion systems utilize neural networks or other machine learning systems to fuse disparate modalities of data, such as image data, RADAR data, and LIDAR data. Neural networks may be designed with a variety of connectivity patterns.

In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

The connections between layers of a neural network may be fully connected or locally connected. FIG. 3A illustrates an example of a fully connected neural network 302. In a fully connected neural network 302, a neuron in a first layer may communicate its output to every neuron in a second layer, so that each neuron in the second layer will receive input from every neuron in the first layer. FIG. 3B illustrates an example of a locally connected neural network 304. In a locally connected neural network 304, a neuron in a first layer may be connected to a limited number of neurons in the second layer. More generally, a locally connected layer of the locally connected neural network 304 may be configured so that each neuron in a layer will have the same or a similar connectivity pattern, but with connections strengths that may have different values (e.g., 310, 312, 314, and 316). The locally connected connectivity pattern may give rise to spatially distinct receptive fields in a higher layer, because the higher layer neurons in a given region may receive inputs that are tuned through training to the properties of a restricted portion of the total input to the network.

One example of a locally connected neural network is a convolutional neural network. FIG. 3C illustrates an example of a convolutional neural network 306. The convolutional neural network 306 may be configured such that the connection strengths associated with the inputs for each neuron in the second layer are shared (e.g., shown as connections 308). Convolutional neural networks may be well suited to problems in which the spatial location of inputs is meaningful. Convolutional neural network 306 may be used to perform one or more aspects of video compression and/or decompression, according to aspects of the present disclosure.

One type of convolutional neural network is a deep convolutional network (DCN). FIG. 3D illustrates a detailed example of a DCN 300 designed to recognize visual features from an image 326 input from an image capturing device 330, such as a car-mounted camera. The DCN 300 of the current example may be trained to identify traffic signs and a number provided on the traffic sign. Of course, the DCN 300 may be trained for other tasks, such as identifying lane markings or identifying traffic lights.

The DCN 300 may be trained with supervised learning. During training, the DCN 300 may be presented with an image, such as the image 326 of a speed limit sign, and a forward pass may then be computed to produce an output 322. The DCN 300 may include a feature extraction section and a classification section. Upon receiving the image 326, a convolutional layer 332 may apply convolutional kernels (not shown) to the image 326 to generate a first set of feature maps 318. As an example, the convolutional kernel for the convolutional layer 332 may be a 5×5 kernel that generates 28×28 feature maps. In the present example, because four different feature maps are generated in the first set of feature maps 318, four different convolutional kernels were applied to the image 326 at the convolutional layer 332. The convolutional kernels may also be referred to as filters or convolutional filters.

The first set of feature maps 318 may be subsampled by a max pooling layer (not shown) to generate a second set of feature maps 320. The max pooling layer reduces the size of the first set of feature maps 318. That is, a size of the second set of feature maps 320, such as 14×14, is less than the size of the first set of feature maps 318, such as 28×28. The reduced size provides similar information to a subsequent layer while reducing memory consumption. The second set of feature maps 320 may be further convolved via one or more subsequent convolutional layers (not shown) to generate one or more subsequent sets of feature maps (not shown).

In the example of FIG. 3D, the second set of feature maps 320 is convolved to generate a first feature vector 324. Furthermore, the first feature vector 324 is further convolved to generate a second feature vector 328. Each feature of the second feature vector 328 may include a number that corresponds to a possible feature of the image 326, such as “sign,” “60,” and “100.” A softmax function (not shown) may convert the numbers in the second feature vector 328 to a probability. As such, an output 322 of the DCN 300 is a probability of the image 326 including one or more features.

In the present example, the probabilities in the output 322 for “sign” and “60” are higher than the probabilities of the others of the output 322, such as “30,” “40,” “50,” “70,” “80,” “90,” and “100”. Before training, the output 322 produced by the DCN 300 is likely to be incorrect. Thus, an error may be calculated between the output 322 and a target output. The target output is the ground truth of the image 326 (e.g., “sign” and “60”). The weights of the DCN 300 may then be adjusted so the output 322 of the DCN 300 is more closely aligned with the target output.

To adjust the weights, a learning algorithm may compute a gradient vector for the weights. The gradient may indicate an amount that an error would increase or decrease if the weight were adjusted. At the top layer, the gradient may correspond directly to the value of a weight connecting an activated neuron in the penultimate layer and a neuron in the output layer. In lower layers, the gradient may depend on the value of the weights and on the computed error gradients of the higher layers. The weights may then be adjusted to reduce the error. This manner of adjusting the weights may be referred to as “back propagation” as it involves a “backward pass” through the neural network.

In practice, the error gradient of weights may be calculated over a small number of examples, so that the calculated gradient approximates the true error gradient. This approximation method may be referred to as stochastic gradient descent. Stochastic gradient descent may be repeated until the achievable error rate of the entire system has stopped decreasing or until the error rate has reached a target level. After learning, the DCN may be presented with new images and a forward pass through the network may yield an output 322 that may be considered an inference or a prediction of the DCN.

Deep belief networks (DBNs) are probabilistic models comprising multiple layers of hidden nodes. DBNs may be used to extract a hierarchical representation of training data sets. A DBN may be obtained by stacking up layers of Restricted Boltzmann Machines (RBMs). An RBM is a type of artificial neural network that can learn a probability distribution over a set of inputs. Because RBMs can learn a probability distribution in the absence of information about the class to which each input should be categorized, RBMs are often used in unsupervised learning. Using a hybrid unsupervised and supervised paradigm, the bottom RBMs of a DBN may be trained in an unsupervised manner and may serve as feature extractors, and the top RBM may be trained in a supervised manner (on a joint distribution of inputs from the previous layer and target classes) and may serve as a classifier.

Deep convolutional networks (DCNs) are networks of convolutional networks, configured with additional pooling and normalization layers. DCNs have achieved state-of-the-art performance on many tasks. DCNs can be trained using supervised learning in which both the input and output targets are known for many exemplars and are used to modify the weights of the network by use of gradient descent methods.

DCNs may be feed-forward networks. In addition, as described above, the connections from a neuron in a first layer of a DCN to a group of neurons in the next higher layer are shared across the neurons in the first layer. The feed-forward and shared connections of DCNs may be exploited for fast processing. The computational burden of a DCN may be much less, for example, than that of a similarly sized neural network that comprises recurrent or feedback connections.

The processing of each layer of a convolutional network may be considered a spatially invariant template or basis projection. If the input is first decomposed into multiple channels, such as the red, green, and blue channels of a color image, then the convolutional network trained on that input may be considered three-dimensional, with two spatial dimensions along the axes of the image and a third dimension capturing color information. The outputs of the convolutional connections may be considered to form a feature map in the subsequent layer, with each element of the feature map (e.g., feature maps 320) receiving input from a range of neurons in the previous layer (e.g., feature maps 318) and from each of the multiple channels. The values in the feature map may be further processed with a non-linearity, such as a rectification, max(0,x). Values from adjacent neurons may be further pooled, which corresponds to down sampling, and may provide additional local invariance and dimensionality reduction.

FIG. 4A is a block diagram illustrating an example of a deep convolutional network 450. The deep convolutional network 450 may include multiple different types of layers based on connectivity and weight sharing. As shown in FIG. 4A, the deep convolutional network 450 includes the convolution blocks 454A, 454B. Each of the convolution blocks 454A, 454B may be configured with a convolution layer (CONV) 456, a normalization layer (LNorm) 458, and a max pooling layer (MAX POOL) 460.

The convolution layers 456 may include one or more convolutional filters, which may be applied to the input data 452 to generate a feature map. Although only two convolution blocks 454A, 454B are shown, the present disclosure is not so limiting, and instead, any number of convolution blocks (e.g., convolution blocks 454A, 454B) may be included in the deep convolutional network 450 according to design preference. The normalization layer 458 may normalize the output of the convolution filters. For example, the normalization layer 458 may provide whitening or lateral inhibition. The max pooling layer 460 may provide down sampling aggregation over space for local invariance and dimensionality reduction.

The parallel filter banks, for example, of a deep convolutional network may be loaded on a CPU 110 or GPU 115 of an SOC 105 to achieve high performance and low power consumption. In alternative aspects, the parallel filter banks may be loaded on the DSP 106 or an ISP 175 of an SOC 105. In addition, the deep convolutional network 450 may access other processing blocks that may be present on the SOC 105, such as sensor processor 155 and navigation module 195, dedicated, respectively, to sensors and navigation.

The deep convolutional network 450 may also include one or more fully connected layers, such as layer 462A (labeled “FC1”) and layer 462B (labeled “FC2”). The deep convolutional network 450 may further include a logistic regression (LR) layer 464. Between each layer 456, 458, 460, 462A, 462B, 464 of the deep convolutional network 450 are weights (not shown) that are to be updated. The output of each of the layers (e.g., 456, 458, 460, 462A, 462B, 464) may serve as an input of a succeeding one of the layers (e.g., 456, 458, 460, 462A, 462B, 464) in the deep convolutional network 450 to learn hierarchical feature representations from input data 452 (e.g., images, audio, video, sensor data and/or other input data) supplied at the first of the convolution blocks 454A. The output of the deep convolutional network 450 is a classification score 466 for the input data 452. The classification score 466 may be a set of probabilities, where each probability is the probability of the input data including a feature from a set of features.

FIG. 4B is a block diagram of an example transformer in accordance with some aspects of the disclosure. In a convolutional neural network (CNN) model, the number of operations required to relate signals from two arbitrary input or output positions grows in the distance between positions, which makes learning dependencies at different distant positions challenging for a CNN model. A transformer 400 reduces the operations of learning dependencies by using an encoder 410 and a decoder 430 that implement an attention mechanism at different positions of a single sequence to compute a representation of that sequence. An attention function can be described as mapping a query and a set of key-value pairs to an output, where the query, keys, values, and output are all vectors. The output is computed as a weighted sum of the values, where the weight assigned to each value is computed by a compatibility function of the query with the corresponding key.

In one example of a transformer, the encoder 410 is composed of a stack of six identical layers and each layer has two sub-layers. The first sub-layer is a multi-head self-attention engine 412, and the second sub-layer is a fully connected feed-forward network 414. A residual connection (not shown) connects around each of the sub-layers followed by normalization.

In this example transformer 400, the decoder 430 is also composed of a stack of six 6 identical layers. The decoder also includes a masked multi-head self-attention engine 432, a multi-head attention engine 434 over the output of the encoder 410, and a fully connected feed-forward network 426. Each layer includes a residual connection (not shown) around the layer, which is followed by layer normalization. The masked multi-head self-attention engine 432 is masked to prevent positions from attending to subsequent positions and ensures that the predictions at position i can depend only on the known outputs at positions less than i (e.g., auto-regression).

In the transformer, the queries, keys, and values are linearly projected by a multi-head attention engine into learned linear projects, and then attention is performed in parallel on each of the learned linear projects, which are concatenated and then projected into final values.

The transformer also includes a positional encoder 440 to encode positions because the model does not contain recurrence and convolution and relative or absolute position of the tokens is needed. In the transformer 400, the positional encodings are added to the input embeddings at the bottom layer of the encoder 410 and the decoder 430. The positional encodings are summed with the embeddings because the positional encodings and embeddings have the same dimensions. A corresponding position decoder 451 is configured to decode the positions of the embeddings for the decoder 430.

In some aspects, the transformer 400 uses self-attention mechanisms to selectively weigh the importance of different parts of an input sequence during processing and allows the model to attend to different parts of the input sequence while generating the output. The input sequence is first embedded into vectors and then passed through multiple layers of self-attention and feed-forward networks. The transformer 400 can process input sequences of variable length, making it well-suited for natural language processing tasks where input lengths can vary greatly. Additionally, the self-attention mechanism allows the transformer 400 to capture long-range dependencies between words in the input sequence, which is difficult for RNNs and CNNs. The transformer with self-attention has achieved results in several natural language processing tasks that are beyond the capabilities of other neural networks and has become a popular choice for language and text applications. For example, the various large language models, such as a generative pretrained transformer (e.g., ChatGPT, etc.) and other current models are types of transformer networks.

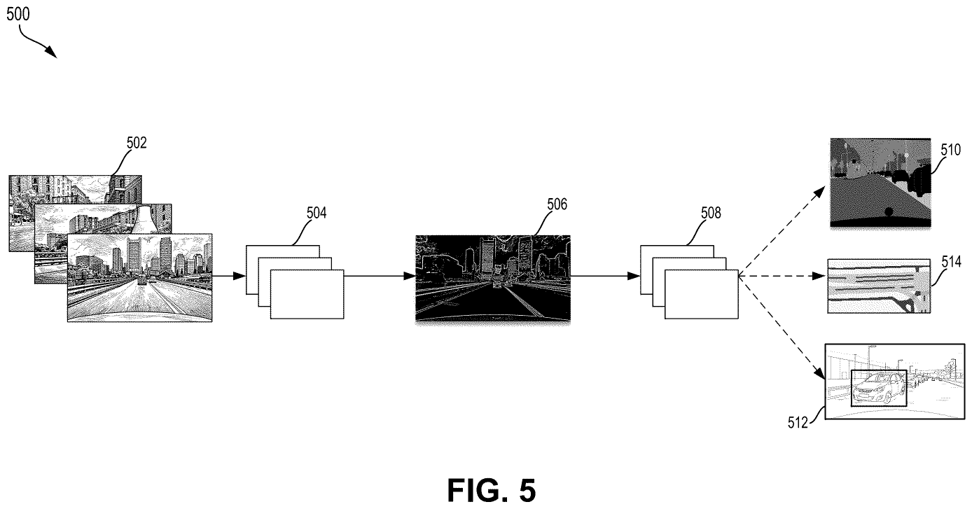

FIG. 5 illustrates a system 500 for processing images for use by a device (e.g., a vehicle or computing system of the vehicle, a mobile device, an extended reality (XR) device, etc.), in accordance with aspects of the present disclosure. As shown in FIG. 5, input camera data 502 (e.g., images captured by cameras such as cameras 122, 136) may be input to feature extractors 504. The feature extractors 504 may be used to identify certain features in the camera data. In some cases, the feature extractors 504 may be ML based. For example, the feature extractors may be implemented as one or more neural networks (NN), convolutional network, or deep convolutional network, such as shown in FIG. 4A and/or FIG. 4B. As an example, the feature extractors 504 may include one or more layers or transformer blocks which may include feature maps for recognizing certain features. The feature extractors 504 may output the identified features as intermediate camera features 506. Of note, while shown as a line drawing, the intermediate camera features 506 may be output as a set of feature vectors.

In some cases, one or more transformation operations 508 may be performed on the intermediate camera features 506. For example, the one or more transformation operations 508 may perform segmentation 510 based on the intermediate camera features 506, perform object detection 512 based on the intermediate camera features 506, or perform a perspective transformation 514 to convert the intermediate camera features 506 from, for example, a frontal view of an environment from a vehicle, to BEV projected camera features, as if features were generated based on a camera positioned above the vehicle. It should be understood that the listed transformations are not intended to be limiting and many other transformation operations may be performed. In some cases, the one or more transformation operations 508 may be ML based. For example, each of the one or more transformation operations 508 may be implemented as one or more neural networks (NN), convolutional network, or deep convolutional network, such as shown in FIGS. 4A and/or 4B.

In some cases, sensor data from multiple sensors, such as camera, RADAR, and LIDAR sensors, may be fused to generate a semantically segmented BEV. In some examples, this sensor fusion may be performed based on the intermediate camera features 506. Information from three dimensions (3D) can be useful for generating the segmented BEV, as information about how far an object is (e.g., depth information) can be useful for separating objects from the background. However, sensors to directly obtain depth information, such as RADAR and LIDAR sensors, can be expensive and can substantially increase costs of the vehicle. Additionally, sensors to directly obtain depth information may draw substantial amounts of power and techniques that can allow use of such sensors to be reduced may help reduce power consumption of vehicles. Techniques to derive depth information using a single camera, providing two dimensional (2D) images, may be useful to help reduce costs, for example, by reducing or eliminating reliance on sensors which can directly obtain depth information.

Generally, it can be easier to estimate a height of an object than to estimate the distance of the object from a viewpoint. For example, for ground-based vehicles that do not need to consider flying objects, a height of an object over a ground plane is image position invariant and scale variant. That is, the height of an object does not change relative to the ground plane no matter where in the image the object is, but the size of the object-ground plane relationship does change where the object is further away from the viewpoint. Thus, a roof of a car is approximately 1.8 meters above the ground, and this is independent of where in the image the roof of the car is located. These properties may be exploited to provide accurate pseudo depth information from captured 2D images, such as those produced by a monocular camera. As an example, some ML models, such as certain types of neural networks, may be more able to reliably handle scale variance (e.g., using stride/pooling) as compared to position invariance for generating predictions.

To allow a ML model to predict distances for features based on height, geometrical distance information may be passed into the ML model, for example, during a training process. This geometrical distance information may be based on geometric properties of images produced by cameras of the vehicle. The geometric properties of the images can be influenced by camera properties, such as the position of the camera on the vehicle, focal length of the camera and lens, distortion from the camera and lens, etc., and the geometrical distance information may be provided based on known camera properties. For example, geometrical distance information may be passed into a ML model using distance map images and these distance map images may be generated based on known geometric properties of the images produced by cameras of the vehicle.

In some cases, additional geometrical distance information may be provided based on predicated variations of the camera properties. For example, a height of the camera may vary due to vehicle suspension movement and during inference, multiple sets of distance map images may be provided based on possible movement of the camera as input to the ML model. In some cases, these multiple sets of distance map images may also be provided along with height information from the vehicle suspension as input to the ML model to help compensate for the movement. In some cases, a camera calibration matrix can include camera properties for a range of cameras, mounting locations, and camera movement to help compensate for different installation locations in different vehicles, different vehicle pitch angles, etc.

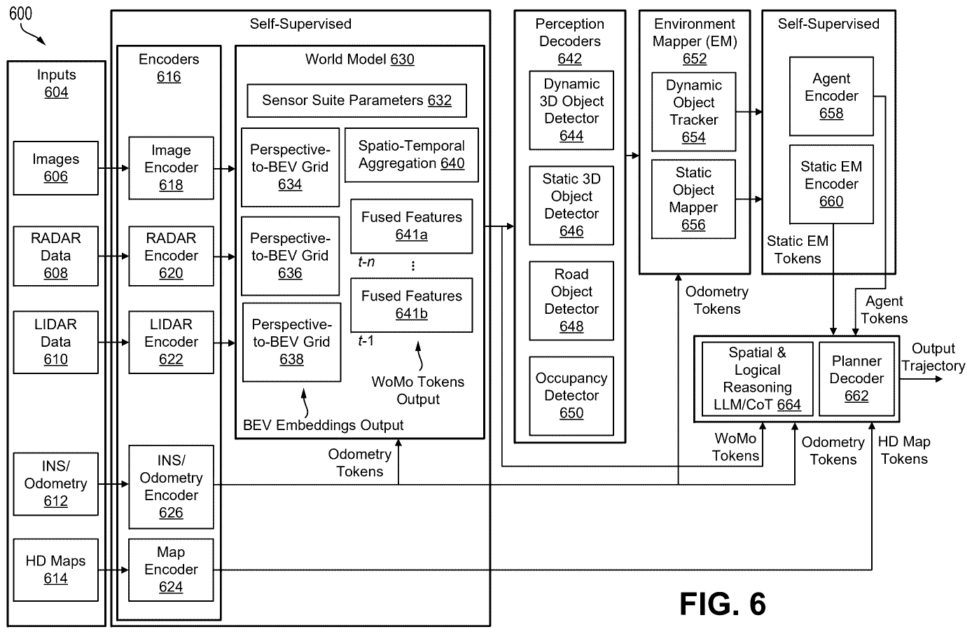

FIG. 6 illustrates an example of an end-to-end system 600 for processing sensor data from a plurality of sensors. As shown, the end-to-end system 600 can process various inputs 604 that includes multi-modal sensor data obtained from a plurality of sensors and/or other sources. The plurality of sensors can be installed or positioned in a vehicle (e.g., an autonomous or semi-autonomous vehicle), not shown in FIG. 6. The vehicle can be referred to as an ego vehicle. Sensor data may include sensor data from the plurality of sensors including camera, LIDAR, RADAR, HD map, odometry. In the example of FIG. 6, the sensor data can include images 606 (e.g., from one or more cameras mounted or in the vehicle, such as the cameras described with respect to FIGS. 1A-2B), RADAR data 608 (e.g., from one or more RADAR sensors of the vehicle, such as the RADAR described with respect to FIGS. 1A-2B), LIDAR data 610 (e.g., a LIDAR point cloud from one or more LIDAR sensors of the vehicle, such as the LIDAR described with respect to FIGS. 1A-2B), HD maps 614 (e.g., from a map server), and inertial navigation system (INS)/odometry data 612 (e.g., from one or more inertial sensors, which may be included in or on the vehicle).

The inputs 604 can be encoded into unified tokens. For instance, the inputs 604 can be provided to encoders 616 (e.g., foundational model (FoMo) encoders) for sensor-level feature extraction and tokenization (e.g., generation of FoMo tokens/feature embeddings). The encoders 616 may include an image encoder 618 for encoding the images 606, a RADAR encoder 620 for encoding the RADAR data 608, a LIDAR encoder 622 for encoding the LIDAR data 610, a map encoder 624 for encoding the HD maps 614, and an INS/odometry encoder 626 for encoding the INS/odometry data 612. In some aspects, each of the tokens (e.g., the FoMo tokens) can correspond to a feature embedding (e.g., an index associated with an N-dimensional feature vector) representing at least a portion of a respective sensor input, and the tokenization performed by the encoders 616 can map features from different sensor modalities into a common embedding dimensionality so that a downstream world model 630 (WoMo) can jointly reason over the sensor modalities.

As previously described, the encoders 616 can include FoMo encoders for sensor level feature extraction (e.g., feature extraction from sensor data). For example, the FoMo encoders may extract FoMo encoded feature embeddings from multi-modal sensor data from the plurality of sensors, denoted as follows:

z_{FoMo}=⊕_{l∈{Image,RADAR,LIDAR,HDMap,Odom.}}fₗ(xₗ), Eq. 1

In the above equation, ⊕ denotes concatenation or merging of feature streams, and each fₗ is a learnable encoder network for a particular sensor modality. Depending on the implementation, the output can be spatial grid features, for example, for images or LIDAR BEV (bird's eye view) projection, sparse tokens, for examples, for bounding queries per RADAR return, and/or learned embeddings for HD map polylines or odometry vectors. The output result collectively can be referenced herein as Z_{FoMo} ∈ [symbol] where N is a total number of extracted tokens and d is a hidden dimension.

In some aspects, the encoders 616 can perform multi-modal tokenization and generate embeddings. For instance, in some cases, encoders 616 may detail how different sensors (e.g., camera, LIDAR, RADAR, HD-map, and INS/odometry) are individually converted into tokens and embeddings to create a unified token representation for subsequent cross-attention and temporal aggregation in the World Model (WoMo) module. By embedding each sensor's output into a consistent dimensionality, the transformer can jointly reason over all sensor modalities without relying on separate dedicated branches.

In some cases, the image encoder 618 includes a camera-to-token encoder (e.g., DINOv2 or other vision encoder or transformer). For instance, a pre-trained encoder (e.g., DINOv2 or other vision encoder or transformer) backbone may be used as camera-to-token encoder to process camera images 606 (captured by one or more camera sensors) to generate tokens from the camera images. For example, given a raw color image (e.g., with red (R), green (G), and blue (B) color components per pixel) denoted I∈ [symbol] ^{H×W×3} (where H corresponds to the height of the image, W corresponds to the width of the image, and “3” corresponds to the three color channels, such as R, G, and B per pixel) the pre-trained encoder (e.g., DINOv2, etc.) can convert I into a grid of patch embeddings as shown below using Eq. 2.

z_{c}=DINOv2(I)∈* [symbol] ^{N}^{_{patch}}^{×d}^{_{c}} Eq. 2

In Equation 2 above, N_{pach} is the number of patches (e.g., H′/p×W′/p for patch size p) and d_{c} represents camera embedding dimension. Each patch embedding captures local appearance features in the image. To unify dimensionality with other sensors, a small learned linear projection W_{c}∈ [symbol] ^{dc×d} mapping from d_{c} to the shared FoMo dimension d using Equation 3 below.

z_{camera}=z_{c}W_{c}∈ [symbol] ^{N}^{_{patch}}^{×d} Eq. 3

Accordingly, 2D or 3D positional encodings are incorporated depending on the camera calibration information.

For instance, if the camera's intrinsic and extrinsic parameters are available, each patch embedding may be augmented with 3D ray features (i.e., projecting patch corners or centers into 3D), which helps the downstream transformer align camera patches with other sensors in a shared coordinate frame.

In some aspects, the LIDAR encoder 622 includes a LIDAR-to-token encoder for processing the LIDAR data 610 from one or more LIDAR sensors to generate a voxel grid representation. For example, LIDAR point clouds P={pi}, with each point pᵢ ∈ [symbol] ⁴ (where the 4 dimensions refer to 3D position plus intensity), are converted into a voxel representation V∈ [symbol] ^{X×Y×Z×C}, where X, Y, Z are the voxel resolutions and C is the channel dimension (e.g., storing density, reflectance, etc.). A 3D convolutional backbone or voxel-based transformer (e.g. Sparse ConvNet) may then be applied to obtain:

$${z}_{LIDAR}^{VOX} = {f}_{voxel} ( V ) ∈ {\text{?}}^{{N}_{lidar} \times {d}_{l}} \qquad Eq . 4$$

In the Eq. 4 above, N_{lidar} represents the number of non-empty voxels (or 3D patches). Similar to the images, a projection layer is applied to LIDAR data for transforming dₗ→d such that:

$${Z}_{lidar} = {z}_{lidar}^{vox} {w}_{l} \qquad Eq . 5$$

In Eq. 5 above, Z_{lidar} represents an embedding of the local LIDAR structure in a voxel. Positional encodings are appended or added indicating the 3D coordinates of each voxel centroid to preserve spatial reference.

In some aspects, the RADAR encoder 620 may include a RADAR-to-token encoder. For instance, the radar data 608 captured by one or more RADAR sensors include point-like detections (e.g., range, azimuth, radial velocity) or dense RADAR data (e.g., range-Doppler maps). In the point-based approach, each RADAR detection rᵢ∈ [symbol] ⁴ (where the four dimensions refer to range, angle, radial velocity, and signal strength) is mapped via a learnable embedding, as shown in Eq. 6 below.

Z_{radar,i}=MLP_{radar}(rᵢ)∈ [symbol] ^{d} Eq. 6

Where MLP is a multilayer perceptron (MLP) or other neural network architecture (e.g., a fully connected layer or other layer of a neural network). In the dense RADAR data approach, the RADAR range-Doppler map is converted into a 2D feature map and 2D convolutions (or a Transformer) are applied to generate a set of RADAR embeddings Z_{radar}ϵ [symbol] ^{N}^{_{radar}}^{×d} with appropriate positional or geometric encodings, such as angle and range offset.

The map encoder 624 can include an HD-Map-to-token encoder (Vector Polylines) for processing the HD maps 614. In general, HD maps provide lane boundaries, drivable areas, crosswalks, traffic signs, and/or other information, which can be in the form of vector polygons or polylines. In some aspects, lane polylines {Lₖ}, each including a sequence of control points {h_{k,1}, h_{k,2}, . . . } in 2D or 3D coordinates, which can be mapped into tokens as follows:

$${z}_{HDMap} = {⊕}_{k} PolyEnc ( {L}_{k} ) , where \qquad Eq . 7$$

$$PolyEnc ( {L}_{k} ) = {⊕}_{j = 1}^{\vert {L}_{k} \vert} {MLP}_{hd} ( {h}_{k , j} ) ∈ {\text{?}}^{{n}_{k} \times d}$$

In Eq. 7 above, nₖ is the number of sampled control points for lane k. Further, if the map includes attributes like lane direction, type of road, traffic rules, etc., the attributes are concatenated as feature vector before the MLP to yield Z_{HDMap}ϵ [symbol] ^{N}^{ₘₐₚ}^{×d} maintaining a sparse representation of static map structures.

In some aspects, the INS/odometry encoder can include an INS/odometry-to-token encoder. For instance, INS and/or odometry data, such as ego pose (of an ego vehicle), inertial measurement unit (IM) readings, velocities, etc., are important or required for ego vehicle localization over time. For example, Oϵ [symbol] ^{d}^{₀} represents odometry features at time t (e.g. (x, y, θ, v, . . . ) for position, heading, speed), odometry features can be mapped into d-dimensional tokens tokens as Eq. 8 below.

z_{odom}=MLP_{odom}(o)∈ [symbol] ^{d} Eq. 8

Accordingly, the INS/Odometry related embedding can be replicated or tiled by combining time or uncertainty steps. INS/Odometry tokens are useful in decoding ego-centric coordinates and handle transformations between local and global frames by the transformer.

In some aspects, a unified FoMo representation may be generated. For example, after projecting each sensor's embedding to dimension d, the embeddings can be merged via concatenation (or other combining technique), as shown in Eq. 9 below.

Z_{FoMo}=Concat(z_{camera},z_{lidar},z_{radar},z_{hdmap},z_{odom})∈ [symbol] ^{(Σ}^{ᵢ}^{N}^{ᵢ}^{)×d} Eq. 9

Additionally, or alternatively, a FoMo-level self-attention block or linear mixing may be performed to refine cross-sensor alignment such that the output is the FoMo embedding Z_{FoMo} that serves as the universal input to the downstream transformer aggregator.

As described herein, by expressing all sensor modalities as tokens in the same feature space, attention modules can treat any sensor feature as a query/key/value, enabling the system to learn cross-sensor associations (e.g., matching LIDAR points to image patches or radars to lanes). Additionally, sparse and flexible representation may be leveraged for relevant tokens instead of constructing large dense grids (e.g. full BEV with 1024×1024 cells), and unified end-to-end training is simplified by having consistent embedding dimensions and shared positional encodings for all modalities for tasks, such as detection, mapping, and planning for consumption for the same shape of data such as [symbol] ^{N×d}. Thus, based on the FoMo encoders, each specialized per sensor type, heterogeneous signals can be unified into one coherent embedding space that allows the downstream transformers to naturally discover inter-sensor correlations, aligning with the philosophy of end-to-end learning in autonomous driving.

The world model 630 can fuse the tokens (e.g., FoMo tokens) from the image encoder 618, the radar encoder 620, and the LIDAR encoder 622 over time. For instance, outputs from the image encoder 618, the radar encoder 620, and the LIDAR encoder 622 can be provided to the world model 630. The world model 630 can process the outputs and generate a unified scene representation as WoMo tokens. The world model 630 can receive and use sensor suite parameters 632 (e.g., denoted as Sₚₐᵣₐₘₛ={Θ_{cam}, Θ_{lidar}, Θ_{radar}, Θₘₐₚ, Θ_{odom}} including intrinsic parameters/extrinsic parameters, rotation/translation, mount angles, and/or other calibration information) to align and fuse sensor features for different sensor configurations.

Tokens in the Bird's-Eye-View (BEV) space can be leveraged by the systems and techniques described herein. For example, as described herein, extracted FoMo tokens can be exploited or used in a BEV representation. As shown in FIG. 6, the world model 630 can include one or more perspective-to-BEV grid transformations 634, 636, 638 configured to map features from a perspective view to BEV embeddings. In some cases, the world model 630 can be a spatio-temporal world model. For instance, the world model 630 can include a spatio-temporal aggregation block 640 configured to fuse BEV embeddings over time (e.g., for times t−n, . . . , t−1, t . . . ) to generate fused features 641a, 641b and corresponding WoMo tokens (e.g., providing a global scene representation). In some examples, the world model 630 can be trained to generate general spatial and temporal features and can predict features for a current frame and/or a subsequent frame based on a history of frames. In some examples, portions of the end-to-end system 600 (e.g., the FoMo encoders 616 and/or the world model 630) can be trained in a self-supervised manner and can be held fixed during inference while one or more task-specific adapters are trained for perception decoders 642.

Two techniques that can be used for mapping token-based features into the BEV space and proceeding in an end-to-end training regime include direct token-to-BEV projection and maintaining tokens in BEV coordinate queries.

As noted, direct token-to-BEV projection (referred to as Option A) can be used to map token-based features into the BEV space. In many autonomous driving pipelines, a BEV representation simplifies reasoning about spatial layouts (e.g. lanes, occupancy, bounding boxes) because it provides a top-down view aligned with the ground plane. The tokens are projected into a grid-based BEV feature map, allowing downstream tasks, such as detection, segmentation, mapping, etc., to operate on a regular 2D convolutional or Transformer-based backbone.

If Z_{FoMo}ϵ [symbol] ^{N×d} represents the set of tokens after merging all sensor modalities, each toke i corresponds to a certain 3D location or region (xᵢ, yᵢ, zᵢ) derived from calibration or LiDAR/RADAR geometry. In a BEV grid of size X×Y (with cell size Δₓ, Δ_{y}), integer cell coordinates may be computed using Eq. 10 shown below.

(uᵢ,vᵢ)=(└xᵢ/Δₓ┘,└yᵢ/Δy┘) Eq. 10

Further, the token embeddings

$${Z}_{{F}_{0} M o}^{( i )}$$

are aggregated into each cell (u, v) by a learnable pooling or attention mechanism using Eq. 11 below.

$${F}_{B E V} ( u , v ) = Ψ ( \{ {z}_{{F}_{0} M o}^{( i )} \vert ( {u}_{i} , {v}_{i} ) = ( u , v ) \} ) \qquad Eq . 11$$

In Eq. 11 above, Ψ(⋅) is a permutation-invariant operator (e.g., average pooling, max pooling, attention pooling). If no token falls into cell (u, v), such token may be placed into a default embedding 0 or a learned empty-cell embedding. The resulting F_{BEV}∈ [symbol] ^{X×Y×d} can be provided as an input to a convolutional backbone of a 2D transformer for further processing using, for example, classic BEV-based methods.

$${F}_{B E V}^{′} = BEV - Backbone ( {F}_{BEV} ) \qquad Eq . 12$$

In Eq. 12 above,

$${F}_{B E V}^{′}$$

is consumed by detection heads, lane-seg modules, and/or occupancy estimators in standard BEV frameworks.

The disclosed option A has certain pros such as the final BEV feature map can leverage existing, well-tested 2D CNN/Transformer heads for object detection and road layout, and the topology is generally straightforward for multi-task heads such as detection, occupancy, etc. Further, the disclosed option A has certain cons such as projecting tokens into discrete BEV cells can lose fine-grained detail, especially for long-range or sparse tokens, and dense grid representation may inflate memory costs, contrary to the advantage of a sparse token design.

As noted, to map token-based features into the BEV space, tokens can be maintained in BEV coordinate queries (referred to as Option B). For instance, in some aspects, instead of constructing a dense X×Y grid, a sparse set of BEV queries, each representing a cell or region of interest in the bird's-eye plane, may be maintained as reminiscent of BEVFormer-style methods (which defines X×Y query embeddings). Additionally, or alternatively, fewer or adaptively placed queries may also be selected.

For example,

$${\{ {q}_{bev} , m \}}_{m = 1}^{M}$$

as a set of M queries, each with associated 2D coordinates (xₘ, yₘ) in the ground plane, an attention-based transform may be applied using Eq. 13 below.

z_{BEV}=BEV-CrossAttention({q_{bev},m},z_{FoMo})∈ [symbol] ^{M×d} Eq. 13

Each BEV query q_{bev}, m attends (e.g., via cross-attention) to all sensor tokens (camera, LiDAR, radar, HD map, etc.), but the attention weights are modulated by geometry, for example, by matching (xₘ, yₙ) in the query with the 3D coordinates of each FoMo token to yield Z_{BEV}, which is a sparse representation of the bird's-eye scene. The sparse representation of the bird's-eye scene may then be provided as input to a smaller BEV-Transformer or a detection head.

However, option B, as described herein, also has certain pros and cons. For example, option B has certain pros, such as the fully attention-based approach retains the token-level flexibility while producing a small number of queries M<<X×Y reducing compute overhead while still focusing on relevant BEV regions. However, option B also has certain cons, such as algorithmic complexity grows with N× M in the cross-attention if M or N is too large. Further, selecting query positions (xₘ, yₙ) requires heuristics or learned placements.

Spatio-temporal World Model (WoMo) aggregation may then be performed using the spatio-temporal aggregation block 640. For example, the world model 630 (using the spatio-temporal aggregation block 640) shown in FIG. 6 can fuse multi-sensor data across space (different sensor modalities) and time (sequential frames of the sensor data over time) to produce a unified scene representation (WoMo tokens). The WoMo tokens capture the global context necessary for downstream tasks such as detection, mapping, and path planning. Construction of the WoMo and interfacing the WoMo with the final planner is described in detail below.

As shown in FIG. 6, sensor suite parameters 632 can be provided as input to the world model 630. For instance, because sensor sets vary across different vehicles or platforms, a sensor suite parameter block can be introduced. As noted previously, the sensor suite parameters 632 can be denoted as Sₚₐᵣₐₘₛ={Θ_{cam}, Θ_{lidar}, Θ_{radar}, Θₘₐₚ, Θ_{odom}}, where the elements Θ include camera calibration Θ_{cam} (intrinsic parameters, extrinsic parameters, also referred to as intrinsics, extrinsics), LIDAR rotation and/or translation Θ_{lidar}, radar mount angles Θ_{radar}, HD-Map calibration Θₘₐₚ, and odometer information Θ_{odom} (e.g., odometer calibration). The system 600 can use these parameters internally (e.g., in FoMo encoders or cross-attention) so that the same architecture can adapt to various sensor configurations.

Token-level spatio-temporal aggregation (or fusion) can be performed by the spatio-temporal aggregation block 640 in some cases. For example, after extracting

$${z}_{F o M o}^{( t )}$$

at each time t (e.g., time t−n, t−1, etc.), the spatio-temporal aggregation block 640 may combine current tokens with a short history as

$${z}_{FoMo}^{( t )} , {z}_{FoMo}^{( t - 1 )} , … , {z}_{FoMo}^{( t - n )} .$$

Accordingly, an output of the spatio-temporal aggregation block 640 at time t may be represented or denoted by

$${z}_{WoMo}^{( t )} ϵ {\text{?}}^{{N}_{w} \times d}$$

where N_{w} corresponds with the total number of WoMo tokens. The spatio-temporal aggregation block 640 may include or be based on a transformer that applies both temporal cross-attention and spatial cross-attention as shown in Eq. 14 and Eq. 15 shown below.

$${z}_{temp}^{( t )} = TemporalAttn ( {z}_{FoMo}^{( t )} , {\{ {z}_{FoMo}^{( t - T )} \}}_{T = 1}^{N} \qquad Eq . 14$$

$${z}_{WoMo}^{( t )} = SpatialAttn ( {z}_{temp}^{( t )} , {S}_{params} ) \qquad Eq . 15$$

TemporalAttn aligns tokens across recent timesteps t−1, . . . , t−n by compensating for ego-motion or sensor motion using Θ_{odom} and other relevant calibrations. SpatialAttn further refine the tokens within a single timestep, attending to the sensor parameter block Sₚₐᵣₐₘₛ, such as camera extrinsic parameters (also referred to as extrinsics), LIDAR pose, etc., so that each token can unify geometric information from different modalities to yield a consistent, combined temporal and spatial representation in the

$${Z}_{WoMo}^{( t )}$$

tokens.

In some aspects, the WoMo tokens can be used as a global scene representation. For example, the produced WoMo tokens

$${z}_{WoMo}^{( t )}$$

can be viewed as the state of the entire scene at time t, after multi-sensor alignment. Each token may represent an object, a patch of drivable space, or a local region in 3D so that tokens

$${z}_{WoMo}^{( t )}$$

can be decoded for tasks such as detection, lane segmentation, or occupancy maps, etc., and passed into an environment mapping (EM) module to keep track of persistent static objects or track dynamic agents, and using them to generate the final trajectory or control signals by the planner decoder.

The WoMo can be useful in building a consistent spatio-temporal world model from any sensor suite, and by incorporating the sensor suite parameter block (Sₚₐᵣₐₘₛ) into the transformer aggregator, geometry from all sensors is seamlessly merged into a single set of WoMo tokens. The single set of WoMo tokens supports multi-task perception and directly feed the planner decoder, preserving end-to-end learnability and modular extensibility for real-world autonomous driving systems.

According to various aspects, the end-to-end system 600 can be configured to perform perception, tracking, prediction, and planning using an integrated framework (e.g., rather than separate perception, tracking, and planning modules), such as by decoding the WoMo tokens using the perception decoders 642 and using the decoded outputs for planning. The perception decoders 642 can include a dynamic 3D object detector 644 trained to detect dynamic (e.g. moving) objects, a static 3D object detector 646 trained to detect static (e.g. moving) objects, a road object detector 648 trained to detect road objects (e.g., stop lights, road signs, road lanes, Bott's dots, etc.), and an occupancy detector 650 trained to detect road occupancy.

The perception decoders of FIG. 6 can include multi-task heads for scene understanding. As described herein, once the WoMo tokens

$${z}_{WoMo}^{( t )}$$

are obtained, the system branches into a suite of the perception decoders 642 dedicated to different tasks including lane detection/mapping, dynamic and/or static 3D object detection, occupancy estimation, and attribute classification (e.g., object behaviors or lane types). The perception decoders 642 operate in parallel, each attending to the shared

$${z}_{WoMo}^{( t )}$$

tokens and possibly producing additional task-specific tokens.

The system 600 of FIG. 6 can provide a unified decoder architecture. For instance, although each perception task is distinct, all different perception tasks can be unified as a transformer-based or convolution-based decoder, for example, for a set of task queries for each perception head.

In one illustrating example, with

$${z}_{WoMo}^{( t )} ϵ {\text{?}}^{Nw \times d}$$

as an input from the world model 630, each perception task k may have query embeddings qₖ∈ [symbol] ^{N}^{ₖ}^{×d}. Accordingly, the perception decoding step or operation can be performed as Eq. 16 below.

$${z}_{k}^{( t )} = TaskDecoder ( {q}_{k} , {z}_{WoMo}^{( t )} ) \qquad Eq . 16$$

In Eq. 16 above,

$${z}_{k}^{( t )}$$

corresponds with, or represents, the final output representation for task k. Each task decoder thus either can be a pure transformer cross-attention module that refines queries qₖ, a lightweight CNN (e.g., if the data is in a BEV or image plane), or a hybrid approach (e.g., first cross-attention to gather relevant tokens, then a convolutional head).

Tasks can include lane detection and mapping in some cases. In tasks such as lane detection (or lane boundary detection) and mapping (or lane mapping), each query may correspond to a point or segment of a lane. Alternatively, WoMo tokens can be projected onto a BEV feature map as discussed above as option A, in which the decoder can be a simple segmentation model as shown using Eq. 17 below.

$$\hat{L} ( u , v ) = σ ( Conv 2 D ( {F}_{BEV}^{′} ( u , v ) ) \qquad Eq . 17$$

In Eq. 17 above, \hat{L} (u, v) is the predicted probability that cell (u, v) belongs to a lane or boundary, and

$${F}_{BEV}^{′}$$

is the BEV feature map derived from WoMo tokens. The loss function Lₗₐₙₑ may be a pixel-wise cross entropy or focal loss.

3D object detection is another example of a task that can be performed by one or more 3D object detection (3DOD) decoders of the system 600. 3D object detection includes detection of dynamic (e.g., by the dynamic 3D object detector 644) and/or static objects (e.g., by the static 3D object detector 646). The 3D object detection may be performed in parallel or as unified queries using maintaining two sets of queries such q_{dyn} for dynamic objects (e.g., vehicles, bicycles, pedestrians, etc.) and qₛₜₐ for static objects (e.g., cones, barriers, poles, etc.).

Both sets of queries attend to

$${z}_{WoMo}^{( t )} .$$

However, each set of queries differs in object categories and output formats. Each object query learns to detect and localize objects in 3D space, as shown using Eq. 18 below.

$$( {\hat{b}}_{i} , {\hat{c}}_{i} ) = {Head}_{box + class} ( {z}_{obj}^{( t )} ( i ) ) \qquad Eq . 18$$

In Eq. 18 above,

$${z}_{obj}^{( t )}$$

represents the i-th query embedding after cross-attention and \hat{b}ᵢ denotes the predicted bounding box (e.g., center, size, rotation), and ĉᵢ represents the class distribution. For dynamic objects, velocities and/or track IDs may be regressed.

Matching and loss functions can be used to train the 3D object detection decoder. In some aspects, Hungarian matching (e.g., as in DEtection TRansformer (DETR)-style methods) may be used to align predicted boxes {\hat{b}ᵢ} with ground-truth boxes

$$\{ {b}_{j}^{*} \}$$

which minimizes a cost function based on intersection-over-union (IoU), L1 distances, and classification errors. The detection loss can sum these terms (IoU, L1 distances, and classification errors) as Eq. 19 below.

$${ℒ}_{3 D - obj} = {\sum }_{i} ( {ℒ}_{cls} ( {\hat{c}}_{i} , {c}_{i}^{*} ) + {λ}_{box} {ℒ}_{box} ( {\hat{b}}_{i} , {b}_{i}^{*} ) ) \qquad Eq . 19$$

The perception decoders 642 can also include the occupancy detector 650, which in some cases can include an occupancy estimation decoder. Occupancy or freespace estimation predicts which regions of the environment are drivable or blocked. For a maintained BEV grid, the occupancy estimation decoder may be a segmentation head and perform convolution operations as illustrated in Eq. 20 below.

$$\hat{O} ( u , v ) = Conv 2 D ( {F}_{BEV}^{′} ( u , v ) ) \qquad Eq . 20$$

The segmentation head, according to Eq. 20, can yield (or generate) a logit or probability for occupancy where a cross-entropy loss can be computed using Eq. 21.

[symbol]

=CE (Ô(u,v),o*(u,v)) Eq. 21

In Eq. 21 above, o*(u, v) corresponds with the ground-truth label of free versus occupied at BEV cell (u, v).

Attribute classification can be performed in some cases. For instance, some use-cases require further attributes beyond object class, for example, turn signal state, vehicle type (car vs. bus), or lane priority, etc. These attributes can be appended as an auxiliary head output on top of the object queries or segmentation outputs. For instance, each object query embedding

$${Z}_{obj}^{( t )} ( i )$$

can produce:

$${\hat{a}}_{i} = MLP ( {Z}_{obj}^{( t )} ( i ) ) \qquad Eq . 22$$

In Eq. 22 above, di is a set of attributes legits (multi-class or multi-label), and the attribute classification loss can be added to the detection matching or handled as a separate head.

In some aspects, training of the system 600 can be based on end-to-end multi-task training. For example, as described herein, the perception decoders or heads (e.g., lane detection, 3D object detection, occupancy detection, attributes or attribute classes, etc.) share the

$${Z}_{WoMo}^{( t )}$$

backbone or the derived BEV feature map

$${F}_{BEV}^{′} ,$$

which can ensure end-to-end learning. A combined perception loss may thus be defined using Eq. 23 below.

[symbol]

In Eq. 23 above, each term is computed by their respective decoder. Gradients flow back (using backpropagation techniques) to the WoMo tokens and ultimately to the FoMo encoders, aligning all components under a single, consolidated pipeline.

Accordingly, the perception decoders, using shared or parallel cross-attention heads, jointly handle lane detection, dynamic/static 3D object detection, occupancy estimation, attribute classification, and any other perception task. Further, by operating on the same WoMo token representation, each task can leverage the spatio-temporal context of the entire scene, facilitating a robust, end-to-end multi-task autonomous driving system.

Outputs of the perception decoders 642 can be provided to an environment mapper (EM) 652. In some aspects, the EM 652 can be used to merge perception outputs into a global scene representation. In some cases, the EM 652 is configured to associate and maintain a persistent scene representation by tracking dynamic objects and mapping static objects in the scene. For example, after each perception decoder produces its specialized outputs (§), the EM 652 may associate and maintain a persistent scene-level representation. As shown in FIG. 6, the EM 652 can include a dynamic object tracker 654 (e.g., for dynamic object association and tracking over time) and a static object mapper 656 (e.g., for mapping static objects and static road elements). As described herein, the static object mapper 656 can also be referred to as a static environment mapper (SEM) and the dynamic object tracker 654 can also be referred to as dynamic environment mapper (DEM). In some aspects, the SEM merges static road elements (lanes, occupancy, road boundaries) and static objects ((traffic cones, poles, barriers) into a long-lived map. In some aspects, the DEM merges dynamic object detections (vehicles, pedestrians) across frames, effectively performing object-level tracking or short-horizon motion estimation.

The EM 652 can then encode both static and dynamic content into separate token embeddings, which feed into subsequent modules, including an agent (or agentic) encoder 658 (for dynamic objects) and a static EM encoder 660 (for static elements), which ensures the entire pipeline maintains a consistent, temporally aware map of the world. SEM and DEM are described in detail below.

In some aspects, the static object mapper 656 can receive as inputs \hat{L} (lane detection or map data), Ô (occupancy estimates), Ŝ (static 3D object detections such as cones, barriers, etc.). Additionally, the static object mapper 656 can access the WoMo tokens

$${Z}_{WoMo}^{( t )}$$

to retrieve any latent cues about the scene geometry.

Merging and association can also be performed. For instance, for lane boundaries or occupancy, the static object mapper 656 merges them over time (e.g., a small temporal filter or multi-frame consistent map). For static objects, the static object mapper 656 can compare the bounding boxes Ŝ from the current frame with previously mapped objects, using a matching process (e.g., IoU-based for 3D bounding boxes) as

$${A}_{static} ( {\hat{S}}^{t} , {M}_{static}^{t - 1} ) \to {M}_{static}^{t} , where {M}_{static}^{t}$$

is the updated static-object map at time t. This association updates each static object's location and status if newly observed or re-observed.

With respect to the static object mapper 656 output, the static object mapper 656 can finally decode the merged static map into static environment tokens, as shown in Eq. 24 below.

$${Z}_{SEM}^{( t )} = StaticEncoder ( {M}_{static}^{t} , \hat{L} , \hat{O} ) ϵ {\text{?}}^{Nsem \times d} \qquad Eq . 24$$

The static environment tokens capture a persistent representation of all static elements. In some cases, the StaticEncoder may be an MLP (e.g., a small MLP) over bounding boxes, lane polyline segments, or BEV patches, a learned transformer aggregator, or other type of neural network layer or model. The final token can be set as

$${Z}_{SEM}^{( t )} ,$$

which can be passed from the static object mapper (or SEM) 656 to subsequent modules (e.g. Static EM Encoder 660) or directly used to assist planning.

The dynamic object tracker (or DEM) 654 of the EM 652 can receive and process dynamic 3D object detections D (e.g., vehicles, pedestrians, bikes, etc.) and in some cases short-term predictions (e.g., if available) of each object's velocity and/or heading as inputs to maintain a record (or short-horizon tracks) of the dynamic agents in the scene.

Latent tracking can be performed in some cases. For instance, instead of a traditional association approach (e.g., using Hungarian matching on bounding boxes across frames), the system 600 can perform a latent space association by reusing the same agent queries over time (e.g., through the temporal cross-attention in the WoMo). However, at the EM level, a more explicit table of track states may be maintained as

$${M}_{dynamic}^{t} = {\{ ( {\hat{b}}_{j} , {\hat{v}}_{j} , {\hat{ι d}}_{j} ) \}}_{j = 1}^{J} ,$$

where each track is updated with bounding box \hat{b}ⱼ, velocity \hat{v}ⱼ, and a track id [symbol] . A short memory or filter (e.g., Kalman filter) may be used to refine each track's pose

$${\hat{b}}_{j}^{t} ⇐ {f}_{kalmm} ( {\hat{b}}_{j}^{t - 1} , {\hat{D}}^{t} ) .$$

After updating the agent states, the dynamic object tracker 654 encodes the updated agent states into dynamic environment tokens as shown in Eq. 25 below.

$${z}_{DEM}^{( t )} = AgenticEncoder ( {M}_{dynamic}^{t} ) ∈ {\text{?}}^{{N}_{dem} \times d} \qquad Eq . 25$$

An MLP or mini-Transformer can translate bounding box/velocity states into token embedding

$${z}_{DEM}^{( t )} ,$$

which provides the latest dynamic scene snapshot in token form.

As shown in FIG. 6, the system 600 can feed the outputs from the EM 652 to subsequent encoders, including a static EM encoder 660 and an agent (or agentic) encoder 658. For instance, the outputs from the EM 652 can be provided to the agent encoder 658 for generating agent tokens (also referred to as agentic tokens) and to the static EM encoder 660 for generating static EM tokens. In some aspects, the static EM encoder can further refine

$${z}_{SEM}^{( t )}$$

(and in some cases can merge

$${z}_{SEM}^{( t )}$$

with the raw WoMo tokens

$${z}_{WoMo}^{( t )} )$$

to produce a unified static scene representation. The unified static scene representation can be helpful for advanced map-based tasks or large-scale semantic understanding. The output might be

$${z}_{staticEM}^{( t )} = StaticEMEcoder ( {z}_{SEM}^{( t )} , {z}_{WoMo}^{( t )} ) .$$

In some cases, the agent encoder 658 can refine or transform

$${z}_{DEM}^{( t )}$$

to incorporate ephemeral context from

$${z}_{WoMo}^{( t )}$$

The result may be a set of agent tokens that represent each dynamic entity with both tracked state and high-level features (e.g., behaviors, intentions), as shown herein, as

$${z}_{agent}^{( t )} = AgenticEncoder ( {z}_{DEM}^{( t )} , {z}_{WoMo}^{( t )} ) .$$

The EM 652 can be important for several reasons, including longer-term memory for static objects, implicit tracking for dynamic objects, and token-based summaries. In longer-term memory for static objects, static objects and road elements are aggregated, and therefore the static object mapper (or SEM) 656 ensures that partially observed structures become fully known over multiple frames that further fosters a stable background for planning, even if sensor coverage or visibility is occasionally poor.

Further, in implicit tracking for dynamic objects, the dynamic object tracker (or DEM) 654 unifies the instantaneous 3D detections with short-horizon predictions, producing a stable set of agent states. This can benefit downstream modules (e.g., path planning) that may need consistent track identifiers (IDs) and velocities, rather than relying solely on ephemeral bounding boxes each frame. Token-based summaries are generated by both the static object mapper 656 and dynamic object tracker 654 as token outputs (Z_{SEM}, Z_{DEM}) that remain transformer-friendly, and can be directly provided as inputs into subsequent transformers or attention blocks (like the planner or advanced multi-agent encoders), which can preserve an end-to-end trainable pipeline.

The EM 652 can act as the glue that consolidates the outputs of the perception decoders 642 (e.g., lane, occupancy, static/dynamic detection, etc.) into a coherent scene-level representation. By separating static versus dynamic data, each part of the EM 652 can apply specialized logic (e.g., persistent map building for static, short-horizon tracking for dynamic). The EM can encode its final state as tokens (z_{SEM}, z_{DEM}), which support advanced reasoning in subsequent modules like the static EM encoder 660 and agent encoder 658 as a combination of multi-task perception with the stable map/tracking needs of real-world autonomous driving.

In some aspects, the agentic and static encoders 658, 660 can be used for tokenizing trajectories and polylines. For instance, after the EM 652 (§) has merged and filtered the outputs of the perception decoders 642, the EM 652 can maintain a persistent map of both dynamic and static elements (via the dynamic object tracker 654 and the static object mapper 656). The dynamic and static elements may require further embedding or tokenization before being passed to, or provided as input to, the planner decoder 662 of FIG. 6. As described herein, two specialized encoders can be used, including the agent (or agentic) encoder 658 for handling dynamic object trajectories, and the static EM encoder 660 for handling static polylines (e.g., lanes, boundaries, etc.). By converting environment-mapped data into tokens, a unified transformer-based approach is enabled for end-to-end autonomous driving.

In some aspects, the agent encoder 658 for the dynamic object tracker (or DEM) 654 maintains a set of tracked agents {(bⱼ, vⱼ, Tⱼ)} over a short horizon. Each agent j may have \hat{b}ⱼϵ [symbol] ⁷ (referring to the bounding box state including 3D center, dimensions, and/or orientation), \hat{v}ⱼϵ [symbol] ² (referring to the linear velocity, possibly with a heading rate), and \hat{T}ⱼ ϵ [symbol] ^{tmax×2} (a short trajectory of tₘₐₓ future positions predicted or smoothed by the dynamic object tracker 654). Additionally, each agent may have a unique track ID to maintain consistency over time.

For trajectory tokenization, each agent's short-horizon trajectory can be converted into a small set of tokens. For example, based on local coordinate frames (e.g. “agent-centric” motion), the following can be defined:

$$Δ {P}_{j}^{( k )} = {\hat{{T}_{j}}}^{( k )} - {\hat{{T}_{j}}}^{( k - 1 )} , k = 1 , … , {t}_{max} \qquad Eq . 26$$

In Eq. 26 above,

$${\hat{{T}_{j}}}^{( k )}$$

denotes the (x,y) position of agent j at future step k. Instead of storing absolute positions, each

$$Δ {P}_{j}^{( k )}$$

represents the incremental displacement. Further, the displacements are quantized or embedded to produce z_{Δ}_{_{P}}ϵ [symbol] ^{tmax×d}.

For agentic embedding, abounding box \hat{b}ⱼ and velocity \hat{v}ⱼ can be encoded (e.g., with an MLP, such as one or more small MLPs, or a multi-level quantization approach), which can result in a single embedding per agent, as shown in Eq. 27 below.

$${z}_{agent}^{( j )} = {MLP}_{b , v} ( [ {\hat{b}}_{j} , {\hat{v}}_{j} ] ) \qquad Eq . 27$$

In Eq. 27 above, [⋅, ⋅] denotes a concatenation operation. Additionally, or alternatively, a track-ID embedding may be added to present identity across frames.

With respect to agentic cross-attention z_{Δ}_{_{P}} may be combined with

$${z}_{agent}^{( j )}$$

by cross attending the trajectory tokens to the agent's summary embedding as shown in Eq. 28 below.

$${z}_{agentic}^{( j )} = AgenticTransformer ( {\{ {z}_{{Δ}_{{p}_{j}}}^{( k )} \}}_{k = 1}^{tmax} , {z}_{agent}^{( j )} ) \qquad Eq . 28$$

Eq. 28 above results in a final embedding

$${Z}_{agentic}^{( j )} ϵ {ℝ}^{d}$$

collapsing the entire short-horizon trajectory for agent j into a single token capturing the agent's dynamic behavior (box state, velocity, planned future path).

Output token(s) can then be generated. For example, the

$${Z}_{a gentic}^{( j )}$$

tokens from all agents j−1, . . . , N_{agent} can be concatenated into, as shown in Eq. 29 below.

$${z}_{D E M} = [ {z}_{agentic}^{( 1 )} , … , {z}_{agentic}^{( {N}_{a g e n t} )} ] \qquad Eq . 29$$

The Z_{DEM} tokens represent the final dynamic scene state from the EM 652, ready for input to the planner decoder 662, or further cross-attention with the static environment tokens.

As noted previously, the system 600 also includes the static EM encoder 660 (also referred to as a static encoder). As input to the static EM encoder 660, the static object mapper (or SEM) 656 can merge lanes, road-boundaries, occupancy polygons, and static objects (e.g. traffic cones, poles) into a single structure, which can be stored as

$${M}_{static}^{t} = \{ ( {ℓ}_{i} ) , ( {s}_{j} ) \} ,$$

where each lᵢ is a polyline (e.g., a lane boundary) defined by a sequence of control points, and each sⱼ is a static object bounding box or location.

Polyline tokenization can be performed for the static EM encoder 660. For example, following a point-based approach, each polyline lᵢ can be represented by points

$$\{ {P}_{i}^{( 1 )} , … , {P}_{i}^{( L i )} \}$$

in 2D or 3D space as embedded by Eq. 30 below.

$${Z}_{P i}^{( k )} = {MLP}_{ℓ} ( {P}_{i}^{( k )} ) ∈ {\text{?}}^{d} , k = 1 , … , Li \qquad Eq . 30$$

Then an internal polyline encoder (PolylineEncoder) can aggregate these point embeddings, such as using Eq. 31, as:

$${Z}_{ℓ i} = PolylineEncoder ( {\{ {Z}_{P i}^{( k )} \}}_{k = 1}^{L i} ) ∈ {\text{?}}^{d} \qquad Eq . 31$$

The internal polyline encoder can aggregate the point embeddings via self-attention (e.g., lightweight self-attention), max pooling, or other operation. The resultant Zₗᵢ is a single token representing the entire lane/road polyline.

Static object embeddings can also be used with the static EM encoder 660. For each static object sⱼ(e.g., a traffic cone), a bounding box or single point location Oⱼ may be embedded using Eq. 32 below.

$${z}_{statobj}^{( j )} = M L {P}_{s} ( {O}_{j} ) ∈ {\text{?}}^{d} \qquad Eq . 32$$

Additionally, if the static object mapper (or SEM) 656 also classifies the static objects (e.g., cone, barrier, pole), the class embedding can be appended to Oⱼ.

The static EM encoder 660 can generate output tokens (referred to as static tokens). For example, all polyline embeddings {zₗᵢ} and object embeddings

$$\{ {z}_{statobj}^{( j )} \}$$

may be collected to form

$${z}_{S E M} = [ {z}_{ℓ1} , … , {z}_{ℓ N ℓ} , {z}_{statobj}^{( 1 )} , {z}_{statobj}^{( {N}_{s t a t} )} ]$$

and may be referenced herein as static tokens. The static tokens can compactly encode the entire set of static map or road elements.

The agent and static tokens are provided as input to the planner decoder 662 (along with, for example, WoMo tokens from the world model 630, HD map tokens from the map encoder 624, and/or odometry tokens from the INS/odometry encoder 626) to generate an output trajectory. Additionally, a spatial and logical reasoning LLM/CoT block 664 can optionally reason over one or more of the tokens and/or the scene representation (e.g., for maneuvers such as turns) to help determine whether the scene representation and/or the output trajectory are logically consistent. For instance, the spatial and logical reasoning LLM/CoT block 664 can optionally inject high-level logical or textual rules, resulting in a final trajectory or control commands for autonomous driving.

For example, once the Z_{DEM} (dynamic tokens) and Z_{SEM} (static tokens) are assembled, they can be concatenated or used in cross-attention by the planner decoder 662, such as shown in Eq. 33 below.

$${z}_{P l a n}^{′} = PlanningDecoder ( {q}_{plan} , [ {z}_{DEM} , {z}_{SEM} ] , {z}_{W o M o}^{( t )} \qquad Eq . 33$$

In Eq. 33 above,

$${z}_{W o M o}^{( t )}$$

is the world-model representation, and qₚₗₐₙ are the planning queries such that the planner decoder 662 has direct token-based access to dynamic object trajectories embedded in Z_{DEM}, static road polylines and objects embedded in Z_{SEM}, and raw sensor or historical context from

$${z}_{W o M o}^{( t )} .$$

Accordingly, the token-level integration, as described herein, enables the planner decoder 662 to reason over the future motion of other agents, the static lanes/obstacles, and the sensor-based environment state in a single, end-to-end transformer stage, and provides advantages such as unified representation (both dynamic (trajectories) and static (polylines) outputs are expressed in tokens, ensuring consistent usage across subsequent attention modules), flexibility (the polyline-based embedding covers arbitrary lane shapes, and the multi-level approach for agent trajectories handles variable time horizons smoothly), and scalability (as the environment changes (new static objects or newly tracked agents), additional tokens are easily appended without altering the entire architecture.

Further, by embedding each agent's short-horizon trajectory and each static polyline into tokens, the agent encoder 658 and static EM encoder 660 form the backbone of E2E scene understanding. The downstream planner decoder 662 can then jointly reason about traffic participants, lanes, and obstacles to plan a safe and optimal ego trajectory.

In some cases, the planner decoder 662 can include spatial and logical reasoning (e.g., through Chain-of-Thought (CoT) reasoning) by incorporating the spatial and logical reasoning LLM/CoT block 664. At the culmination of the system 600, the system can produce an ego-trajectory plan given all the relevant context, such as HD map tokens, dynamic (agentic) tokens, static tokens (lanes, polygons), the spatio-temporal WoMo tokens, odometry tokens, and any additional data or metadata. As described below, the planner decoder 662 can fuse these diverse tokens and can leverage the spatial and logical reasoning LLM/CoT block 664 for higher-level logical reasoning. The resulting output is a planned trajectory (shown as an output trajectory) and/or control sequence for the autonomous or semi-autonomous vehicle.

The planner decoder 662 can receive a plurality of token sets as inputs. The plurality of token sets includes HD Map Tokens (Z_{HDMap}, which is vectorized or VQ-encoded map segments (lanes, drivable areas) from the FoMo map encoder 624 and/or from the static EM encoder 660, providing the global road layout), Agentic Tokens (Z_{DEM}, which are embeddings of dynamic agents (vehicles, pedestrians), including short-horizon trajectories or velocity states), Static Tokens (Z_{SEM}, which are polylines (road boundaries, lane connectors, etc.) and static objects (cones, barriers), WoMo Tokens

$$( {Z}_{W o M o}^{( t )}$$

describing the spatio-temporal context from the World Model aggregator (§), which contains raw sensor features and historical cues), and Odometry Tokens (Z_{odom} that are discretized or MLP-encoded ego state (pose, velocity, orientation) from INS/odometry data 612).

Additionally, the planner decoder 662 may maintain a set of plan queries qₚₗₐₙϵ [symbol] ^{Nplan×d} as either learned or initialized with heuristic positions. Further, the queries in the set of plan queries may attend to all input tokens to form the final plan (e.g., represented by the output trajectory).

The planner decoder 662 can perform a unified attention mechanism (e.g., multi-context cross-attention). For instance, in some aspects, the unified attention mechanism may merge the above-described inputs to the planner decoder 662 into a single transformer decoder, as shown below in Eq. 34. For instance, in each Transformer layer,

$${z}_{plan}^{′} = MultiCrossAttn ( {q}_{p l a n} , [ {z}_{H D M a p} , {z}_{DEM} , {z}_{S E M} , {z}_{W o M o}^{( t )} , {z}_{o d o m} ] ) \qquad Eq . 34$$

In Eq. 34 above,

$${z}_{plan}^{′} ϵ {\text{?}}^{Nplan x d}$$

represents the refined planning queries after one layer of cross-attention. The aggregator bracket [ ] denotes concatenation of token sets along the (batch, token) dimension, so the planning queries can access all relevant modalities in a single pass.

In some cases, layer stacking can be performed. For example, L layers of the cross-attention and feed-forward blocks can be stacked such that each layer updates

$${z}_{plan}^{( ℓ )}$$

via Eq. 35 below.

$${z}_{plan}^{( ℓ + 1 )} = FFN ( MultiCrossAttn ( {z}_{plan}^{( ℓ )} , [ {z}_{HDMap} , {z}_{DEM} , {z}_{SEM} , {z}_{WoMo}^{( t )} , {z}_{odom} ] ) ) \qquad Eq . 35$$

In complex driving scenarios (e.g., unprotected left turns, merging with multiple agents), it can be helpful to augment raw attention with higher-level logical or rule-based reasoning. As noted previously, the CoT block 664 can provide spatial and logical reasoning. For instance, the CoT block 664 can interpret the final token embeddings and combine them with textual or symbolic traffic rules.

For inputs to the CoT block 664,

$${z}_{plan}^{( final )}$$

denotes the plan queries after L decoder layers. Rule embeddings R and Chain-of-Thought State (h_{CoT}) can also be maintained. Rule Embeddings R are short textual representations of traffic laws or route-level instructions (e.g. “yield at crosswalk if pedestrian is 3 meters away”), which are embedded by a language model or a learnable dictionary. Chain-of-Thought State (h_{CoT}) is a hidden memory vector that accumulates partial reasoning steps or intermediate logic.

To provide a reasoning mechanism, the CoT block 664 can be formulated as a neural network (e.g., a small transformer or recurrent neural network (RNN)) that unrolls M steps, merging the plan tokens with textual or symbolic instructions as shown in Eq. 36 and Eq. 37 below.

$${h}_{CoT}^{( m + 1 )} = ReasoningUnit ( [ {z}_{plan}^{( final )} ; R ] , {h}_{CoT}^{( m )} ) \qquad Eq . 36$$

$${z}_{plan}^{′} = LN ( {h}_{CoT}^{( m )} ) \qquad Eq . 37$$

In Eq. 36 and Eq. 37 above,

$${h}_{CoT}^{( 0 )}$$

is initialized to zero or a learned vector, and a reasoning unit (ReasoningUnit) can be an attention-based block that processes textual tokens (R) and plan tokens

$${z}_{plan}^{( final )} .$$

LN denotes layer normalization, and M is a hyper-parameter controlling how many iterative steps of reasoning can be performed.

The CoT block 664 can capture constraints, such as yield to traffic in an oncoming lane for left turns, stop before a crosswalk if a pedestrian is dangerously close, maintain speed limit, and/or follow route-lane instructions, etc. Using the CoT block, the textual or symbolic knowledge is learned or curated, and applied as multi-modal attention between traffic rules, agent states, and the partial plan.

As noted previously, the output of the planner decoder 662 can include a trajectory and/or a control output for the ego vehicle. For example, the planner decoder 662 (or head) can predict future trajectory and/or control signals for the ego vehicle. In some cases,

$${z}_{plan}^{′} ϵ {ℝ}^{{N}_{plan} \times d}$$

may be the post-CoT representation and may be decoded with a simple MLP or multi-head using Eq. 38 below.

$${\hat{T}}_{ego} = {MLP}_{traj} ( {z}_{plan}^{′} ) ϵ {ℝ}^{{T}_{horizon} \times 3} \qquad Eq . 38$$

In Eq. 38 above, each row might be (x, y, θ) or (steer, acc, brake) commands for T_{horizon} future steps.

With respect to losses and training of the system 600, a planning loss may be defined as comparing \hat{T}_{ego} to a ground-truth

$${T}_{ego}^{*} .$$

For instance, an L₁ or L₂ norm,

$${ℒ}_{plan} = {‖ {\hat{T}}_{ego} - {T}_{ego}^{*} ‖}_{1} + ( possible collision or route penalty ) .$$

Further, gradients flow back through the entire planner stack, which includes the CoT block 664.

Accordingly, the planner decoder 662, as described herein, CoT block multi-context cross-attention merging HD map tokens, agentic tokens, static tokens, WoMo tokens, and odometry tokens into the plan queries via the transformer layers. Further, the CoT block 664 can (optionally) inject high-level logic or textual traffic rules, yielding additional interpretative reasoning for safe, rule-compliant planning. Additionally, A trajectory/control head can produce the final (x, y, θ) or control commands for the ego vehicle, trained under a standard trajectory loss.

The systems and techniques described herein ensure that all relevant scene information, both sensor-driven and rule-based, flows into a unified, end-to-end plan that can be optimized holistically. The optional CoT block 664 can help handle complex logic or advanced interactions that are not trivially captured by standard attention alone, bridging the gap between learned features and explicit reasoning in autonomous driving.

In some aspects, while various modules in the system 600, such as the encoders 616, the world model (WoMo) 630, the perception decoders 642, the environment mapper (EM) 652, the agentic and static encoders 658, 660, and the planner decoder 662 are described above, a unified end-to-end (E2E) training approach can be performed (as described below) so that each component is jointly optimized under a single objective.

The end-to-end training can be based on a unified loss made up of multi-task loss terms, such as perception loss, map construction loss, trajectory/agent association loss, and planning loss.

The multi-task loss terms can include principal losses associated with various modules described herein, and can include perception loss, map construction loss, trajectory/agent associated loss, planning loss, and unified loss, each of which is described below.

Perception loss denotes the object detection, lane/road segmentation, occupancy estimation, and any other perception tasks collectively as [symbol] + [symbol] + . . . , which sums classification, bounding-box regression, and segmentation losses/costs as appropriate.

For the static object mapper 656, the map construction loss may be defined as [symbol] =λₘₐₚ ( [symbol] ), which captures the accuracy of lane polylines, static boundaries, or other vectorized map elements.

With respect to trajectory/agent association loss, if dynamic agents (e.g., 3D bounding boxes, short-horizon motion, etc.) are supervised, a Hungarian-matching style detection or track loss, plus motion regression, may be incorporated as [symbol] =λ_{track} [symbol] +λₜᵣₐⱼ [symbol] which can ensure objects are detected or tracked correctly and that their predicted trajectories align with the ground truth.

The planner decoder 662 output, \hat{T}_{ego} can be matched to the ground-truth ego trajectory

$${T}_{ego}^{*}$$

to determine the planning loss. In some cases, the planning loss may be defined based on one or more losses (e.g., L₁ loss, L₂loss, Gaussian negative log-likelihood, etc.). The planning loss can be denoted as

$${ℒ}_{plan} = {‖ {\hat{T}}_{ego} - {T}_{ego}^{*} ‖}_{1} + …$$

to which additional terms (collision avoidance, route completion, smoothness, etc.) can also be appended.

A unified loss can be determined. For instance, the unified is total training objective that can be a weighted sum of all major components (e.g., losses), so that each module learns to serve the final E2E goal. The unified loss may be defined as shown in Eq. 39 below.

$${ℒ}_{plan} = {ℒ}_{plan} + {ℒ}_{plan} + {ℒ}_{plan} + {ℒ}_{plan} + {λ}_{reg} {‖ θ ‖}_{2}^{2} \qquad Eq . 39$$

In Eq. 39, 0 represents the collection of trainable parameters across all modules (encoders, transformers, decoders), and λ_{reg} is a standard weight decay or regularization coefficient.

Several example algorithms are described below. In the algorithm, comments are preceded by ‘//’.

Algorithm 1: Multi-modal FoMo and WoMo based E2E Architecture

This algorithm takes as input

$${\{ {I}_{c} \}}_{c = 1}^{{N}_{c}} ( cameras ) , {\{ {R}_{r} \}}_{r = 1}^{{N}_{r}} ( radar ) ,$$

L (LiDAR), H (HD-map), 0 (odometry or INS data), and sensor calibration parameters Sₚₐᵣₐₘₛ.

Further, this algorithm ensures ego trajectory \hat{T}_{ego} or control signals.
1: Z_{camera}=DINOv2(I_{c})·W_{c}//Camera-to-Token using Vision Transformer
2: Z_{lidar}=fᵥₒₓₑₗ(V)·wₗ//LiDAR-to-Token via 3D voxelization
3: Z_{radar,I}=MLP_{radar}(rᵢ) for each radar detection rᵢ//Radar-to-Token encoding
4: Z_{HDMap}=⊕ₖPolyEnc(Lₖ)//HD-Map-to-Token for polylines
5: Z_{odom}=MLP_{odom}(O)//Odometry-to-Token for ego state
6: Z_{FoMo}=Concat (Z_{camera}, Z_{lidar}, Z_{radar}, Z_{HDMap}, Z_{odom})//Unified FoMo representation
7:

$${z}_{temp}^{( t )} = Temporal Attn ( {Z}_{{F}_{0} Mo}^{( t )} , {\{ {Z}_{FoMo}^{( t - T )} \}}_{T = 1}^{n} )$$

//Temporal cross-attention over history
8:

$${z}_{WoMo}^{( t )} = SpatialAttan ( {z}_{temp}^{( t )} , Sparams )$$

//Spatial cross-attention with sensor alignment
9: for each perception task k∈{lane, obj, occ, attr} do
10:

$${Z}_{k}^{( t )} = TaskDecoder ( {q}_{k} , {z}_{WoMo}^{( t )} )$$

//Task-specific decoding using queries
11: Apply task-specific heads to obtain Lane Detection outputs \hat{L}(u, v), 3D object detection outputs (\hat{b}ᵢ, ĉᵢ) for dynamic or static objects, occupancy estimation Ô(u, v), and object attributes âᵢ.
12: end for
13: For static elements (SEM):
14:

$${M}_{static}^{t} = {A}_{static} ( {\hat{S}}^{t} , {M}_{static}^{t - 1} )$$

//Update static map with associations
15:

$${Z}_{SEM}^{( t )} = StaticEncoder ( {M}_{static}^{t} , \hat{L} , \hat{O} )$$

//Encode static elements to tokens
16: For dynamic elements (DEM):
17:

$${M}_{d y n a m i c}^{t} = Update tracked agents with detections \hat{D}$$

//Track dynamic objects over time
18:

$${Z}_{DEM}^{( t )} = AgenticEncoder ( {M}_{dynamic}^{t} )$$

//Encode dynamic agents to tokens
19: For each agent:
20:

$${Z}_{agentic}^{( j )} = AgenticTransformer ( {\{ Z Δ {P}_{j}^{( k )} \}}_{k = 1}^{tmax} , {Z}_{agent}^{( j )} )$$

//Encode agent trajectories
21:

$${Z}_{DEM} = [ {Z}_{agentic}^{( 1 )} , … , {Z}_{agentic}^{( Nagent )} ]$$

//Collect all agent tokens
22: For Static elements:
23:

$${Z}_{SEM} = [ {Z}_{ℓ l} , … , {Z}_{ℓ N ℓ} , {Z}_{statobj}^{( 1 )} , {Z}_{statobj}^{( Nstat )} ]$$

//Collect all static tokens
24: for l=1 to L do:
25:

$${z}_{plan}^{( ℓ + 1 )} = FFN ( MultiCrossAttn ( {z}_{plan}^{( ℓ )} , [ {Z}_{HDMap} , {Z}_{DEM} , {Z}_{SEM} , {Z}_{WoMo}^{( t )} , {Z}_{odom} ] ) )$$

//Planning transformer layer
26: end for
27: If using Chain-of-Thought (CoT):
28: Initialize

$${h}_{C o T}^{( 0 )}$$

//Initialize reasoning state
29: for m=0 to M−1 do:
30:

$${h}_{CoT}^{( m + 1 )} = ReasoningUnit ( [ {z}_{plan}^{( final )} ; R ] , {h}_{CoT}^{( m )} )$$

//Apply logical reasoning steps
31: end for
32:

$${z}_{plan}^{′} = LN ( {h}_{CoT}^{( m )} )$$

//Normalize final reasoning state
33:

$${\hat{T}}_{ego} = {MLP}_{traj} ( {z}_{plan}^{′} )$$

//Decode final trajectory or controls
34: return \hat{T}_{ego}//Return ego trajectory plan

### Algorithm 2: FoMo Encoder for Camera

This algorithm takes as input a camera image Iϵ [symbol] ^{H×W×3} and camera calibration parameters Θ_{cam}, and ensures token embeddings Z_{camera}.
1: Apply Vision Transformer://First stage of tokenization
2: Z_{camera}=DINOv2(I)ϵ [symbol] ^{Npatchxdc}//Extract patch embeddings from image
3: Project to Common Dimension://Unify embedding dimension with other sensors
4: Z_{camera}=Z_{c} W_{c}ϵ [symbol] ^{Npatched}//Linear projection to shared dimension d
5: Add Positional Encodings//Preserve spatial information
6: if 2D positional encodings then
7: Add 2D grid position embeddings
8: else if 3D positional encodings then
9: Project patch centers via camera calibration Θ_{cam}//Maps 2D pixels to 3D rays
10: Add 3D positional embeddings//For multi-sensor spatial alignment
11: end if
12: return Z_{camera}//Return camera token embeddings

### Algorithm 3: WoMo Aggregation

This algorithm takes as input FoMo tokens

$${Z}_{FoMo}^{( t )}$$

at current time t, history

$${\{ {Z}_{FoMo}^{( t - T )} \}}_{T = 1}^{N} ,$$

and sensor parameters Sₚₐᵣₐₘₛ to ensure WoMo tokens

$${Z}_{WoMo}^{( t )} .$$

1: Temporal Fusion://Merge information across time frames
2: Apply ego-motion compensation based on odometry//Align history tokens to current frame
3:

$${Z}_{temp}^{( t )} = TemporalAttn ( {Z}_{FoMo}^{( t )} , {\{ {Z}_{FoMo}^{( t - T )} \}}_{T = 1}^{N}$$

//Cross-attend current to past frames
4:

$$Query = {Z}_{F o M o}^{( t )}$$

//Current frame acts as query
5:

$$Keys / Values = {\{ {Z}_{F o M o}^{( t - T )} \}}_{T = 1}^{N} ( motion - compensated )$$

//Past frames act as
   keys/values
6: Spatial Fusion//Merge information across sensor modalities
7: Apply geometric calibration using Sₚₐᵣₐₘₛ//Account for sensor mounting positions
8:

$${Z}_{W o M o}^{( t )} = SpatialAttn ( {Z}_{temp}^{( t )} , {S}_{params} )$$

//Cross-attend across sensor tokens
9: Self-attention or cross-attention among tokens//Integrate multi-modal information
10: return

$${Z}_{W o M o}^{( t )}$$

//Return world model tokens

### Algorithm 4: Environment Mapper (EM) for Dynamic Objects

This algorithm takes as input dynamic objects detections \hat{D}, previous tracks

$${M}_{d y n a m i c}^{t - 1}$$

to ensure updated tracks

$${M}_{d y n a m i c}^{t}$$

and dynamic tokens Z_{DEM}.
1: Track update://Associate current detection with existing tracks
2: for each detected object i in \hat{D} do
3: Match with existing tracks in

$${M}_{d y n a m i c}^{t - 1}$$

using IoU or distance//Find closest match
4: Update matched tracks, create new tracks for unmatched detections//Handle track creations/updating
5: end for
6:

$${M}_{d y n a m i c}^{t} = \{ ( {\hat{b}}_{j} , {\hat{v}}_{j} , {\hat{T}}_{j} , {\hat{ι d}}_{j} ) \}$$

for all j tracks//Store bounding box, velocity, trajectory, ID
7: Trajectory tokenization:
8: for each track j do
9: Compute displacements:

$$Δ {P}_{j}^{( k )} = {\hat{T}}_{j}^{( k )} - {\hat{T}}_{j}^{( k - 1 )}$$

//Relative motion rather than absolute
10: Encode displacements: Z ΔPⱼ=MLP(Δ_{P}_{ⱼ})//Embed motion patterns
11: Encode agent state:

$${Z}_{a gent}^{( j )} = M L {P}_{b , v} ( [ {\hat{b}}_{j} , {\hat{v}}_{j} ] )$$

//Embed static properties
12: end for
13: Agentic fusion://Combine motion and properties into unified embedding
14: for each track j do
15:

$${Z}_{agentic}^{( j )} = A g e n t i c T r a n s f o r m e r ( {\{ Z Δ {P}_{j}^{( k )} \}}_{k = 1}^{tmax} , {Z}_{a gent}^{( j )} )$$

//Cross-attend trajectory to agent
16: end for
17: Aggregate dynamic tokens://Collect all agent embeddings
18:

$${Z}_{D E M} = [ {Z}_{a gentic}^{( 1 )} , … , {Z}_{a gentic}^{( N a g e n t )} ]$$

//Stack into batch of tokens
19: return Z_{DEM},

$${M}_{d y n a m i c}^{t}$$

//Return tokens and updated tracks

The end-to-end framework provided by the system 600 includes various new features, including FoMo-Based multi-modal tokenization (e.g., via the encoders 616), a World Model (WoMo) aggregator (e.g., the spatio-temporal aggregation block 640) for spatio-temporal fusion, Environment Mapper (EM) 652 with Tokenized Output, Agentic and Static Encoders (e.g., agent encoder 658 and static EM encoder 660) for Higher-Level Representation, a Chain-of-Thought (CoT) block 664 in the planner, True End-to-End (E2E) Single-Stage Training, Scalability and Modularity, among others, as described herein.

The system 600 provides FoMo-based multi-modal tokenization. Such tokenization provides flexible token representations. For instance, unlike classical BEV or purely image-based pipelines, each sensor (e.g., camera, LIDAR, RADAR, HD map, odometry, etc.) is converted into tokens (e.g., referred to as “FoMo tokens”) that preserve high-fidelity information without forcing a dense grid representation. The multi-modal tokenization also provides unified dimensionality. For example, all sensor tokens share the same embedding dimension, enabling straightforward cross-sensor attention in subsequent modules.

The system 600 also provides the WoMo aggregator (the spatial-temporal aggregation block 640) for spatio-temporal fusion. Such a setup allows streaming temporal cross-attention. For instance, rather than storing large 2D or 3D features for multiple frames, the system 600 can maintain a sparse set of tokens for each timestep and fuse them via temporal cross-attention. The WoMo aggregator also allows parallel spatial cross-attention, where the same representation also unifies spatial context from multiple sensors, alleviating multi-stage or separate-lane fusion.

The system 600 also provides the EM 652 with tokenized output, including parallel static and dynamic mappers (e.g., the static object mapper 656 and the dynamic object tracker 654). For instance, the EM 652 can distinctly handle static map elements (lanes, roads, signs) the via static object mapper (or static (SEM)) 656 and dynamic objects (vehicles, pedestrians) via the dynamic object tracker 654, and can merge them into token embeddings for a consistent scene-level representation. The EM 652 provides short-horizon tracking without separate modules. For example, dynamic object states and short-horizon trajectories can be updated in one pass, producing agentic tokens that incorporate motion information without heavy or ad-hoc tracking logic.

The agentic and static encoders 658, 660 provide for higher-level representations. Such encoders allow for trajectory-level summaries. For instance, agents' short-horizon futures can be converted into compact embeddings (via multi-level quantization or local coordinate frames) and then aggregated into single tokens for easy consumption by the planner. The agentic and static encoders 658, 660 also allow for polyline-level summaries. For example, lanes and static boundaries can be aggregated into individual tokens via a lightweight polyline encoder, preserving geometry while reducing computation overhead.

The CoT block 664 in the planner provides logical or textual rule integration. For example, beyond raw attention over tokens, the CoT block 664 can incorporate traffic rules or route instructions (e.g., in textual or symbolic form) to handle nuanced interactions (e.g., unprotected left turns, crosswalk yields). The CoT block 664 also provides iterative reasoning steps, such as by letting the model combine learned features with explicit, human-like logic for more robust planning decisions.

The system 600 also allows for a true end-to-end single-stage training. For instance, using the single unified objective, a single training run can jointly optimize perception (e.g., detection, mapping, occupancy, etc.), dynamic tracking, and final planning. Using the end-to-end training, no manual phasing is needed. For example, no manual phasing removes the need for multi-phase or separate-module pretraining (e.g., detection→motion→planning), mitigating error propagation among modules.

The system 600 provides scalability and modularity. For example, the system 600 allows for plug-and-play sensors. For instance, due to the FoMo approach and sensor calibration block, new sensors (e.g., an additional RADAR, LIDAR, camera, etc.) can be added with minimal changes to the architecture. The sparse, token-based design provides for scalability. For example, the token-based architecture naturally scales to large scenes and extended temporal horizons by controlling the number of tokens, rather than expanding dense grids or building dedicated modules for each sensor or sub-task.

Overall, the aspects described herein create a coherent end-to-end pipeline that unifies perception, mapping, and planning under a single Transformer-based design, with a strong focus on sparse tokenization, temporal fusion, and optional logical (CoT) reasoning for safer, more versatile autonomous driving.

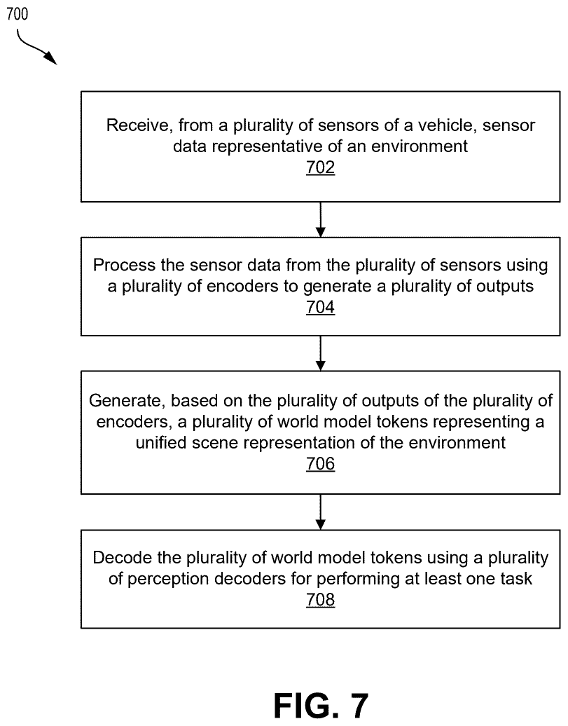

FIG. 7 is a flow diagram illustrating a process 700 for generating a single-stage, end-to-end neural architecture that tokenizes all sensor inputs, building a unified spatio-temporal world model, and planning the ego trajectory in a logically consistent way. As described herein, by aligning all tasks under one jointly trained Transformer-based design, the disclosed process aims to improve performance and stability compared to multi-module pipelines, allow for flexible sensor suite expansion or modifications, and seamlessly integrate rule-based or textual knowledge (Chain-of-Thought) to handle complex driving maneuvers and traffic regulations.

The process 700 may be performed by a computing device (or apparatus) or a component (e.g., a chipset, codec, etc.) of the computing device. In some examples, the processes described herein (e.g., process 700 and/or other process described herein) may be performed by a computing device or apparatus (e.g., SOC 105 of FIG. 1D). In some examples, the process 700 may be performed by the vehicle 100 of FIG. 1A or by a component or system of the vehicle 100, such as the vehicle 100 implementing the system 600 of FIG. 6. In some cases, the computing device may be included with or a part of a system, such as the vehicle management system 200 implementing the system 600 of FIG. 6. The operations of the process 700 may be implemented as software components that are executed and run on one or more processors, such as to perform the operations described with respect to the system 600 of FIG. 6.

At block 702, the computing device (or component thereof) may receive, from a plurality of sensors, sensor data representative of an environment. The plurality of sensors may be positioned in a vehicle, such as an autonomous or semi-autonomous vehicle. For example, the plurality of sensors can include one or more camera sensors, one or more LIDAR sensors, one or more RADAR sensors, HD Maps, INS sensors, odometry sensors, etc. The sensor data can include a plurality of images from the camera sensor(s), a plurality of RADAR feature maps from the RADAR sensor(s), a plurality of LiDAR-based feature maps from the LIDAR sensor(s), HD-map features, odometry data, etc.

At block 704, the computing device (or component thereof) may process the sensor data from the plurality of sensors using a plurality of encoders (e.g., the foundational model (FoMo) encoders of FIG. 6) to generate a plurality of outputs. For example, the plurality of outputs can be generated using the plurality of encoders based on processing of the sensor data. The plurality of outputs of the plurality of encoders can include spatial grid features, sparse tokens, learned embeddings, any combination thereof, and/or other outputs. Additionally or alternatively, the plurality of outputs may include bird's eye view (BEV) embeddings, HD map tokens, odometry tokens, any combination thereof, and/or other outputs.

At block 706, the computing device (or component thereof) may generate a plurality of World-Model (WoMo) tokens representing a unified scene representation of the environment (e.g., across different modalities corresponding to the different sensors and times corresponding to sensor data processed over a period of time). The plurality of WoMo tokens are generated based on the plurality of outputs of the plurality of FoMo encoders. The computing device (or component thereof) may decode the plurality of WoMo tokens using a plurality of perception decoders and generate a plurality of static objects, a plurality of dynamic objects, occupancy graphs, etc. including various static and/or dynamic objects.

At block 708, the computing device (or component thereof) may decode the plurality of WoMo tokens using a plurality of perception decoders for performing at least one task (e.g., lane detection, lane mapping, static object detection, dynamic object detection, occupancy estimation, attribute classification tasks, etc.).

Additionally, or alternatively, the computing device (or component thereof) may generate, based on processing of the sensor data using the plurality of FoMo encoders, a unified embedding. The unified embedding can be generated by concatenating embeddings based on sensor data corresponding to each sensor of the plurality of sensors. The computing device (or component thereof) may provide the unified embedding as input to a transformer aggregator.

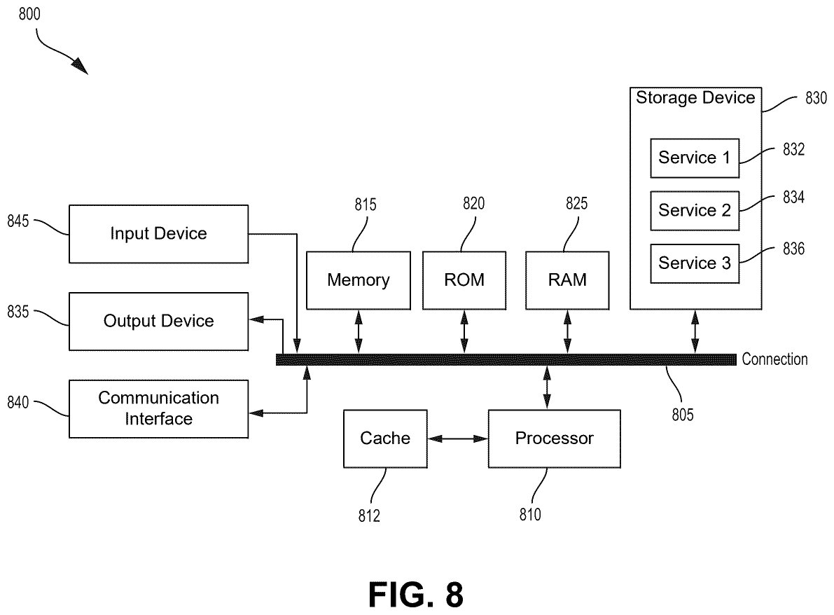

FIG. 8 is a diagram illustrating an example of a system for implementing certain aspects of the present technology. In particular, FIG. 8 illustrates an example of computing system 800, which may be for example any computing device making up internal computing system, a remote computing system, a camera, or any component thereof in which the components of the system are in communication with each other using connection 805. Connection 805 may be a physical connection using a bus, or a direct connection into processor 810, such as in a chipset architecture. Connection 805 may also be a virtual connection, networked connection, or logical connection.

In some aspects, computing system 800 is a distributed system in which the functions described in this disclosure may be distributed within a datacenter, multiple data centers, a peer network, etc. In some aspects, one or more of the described system components represents many such components each performing some or all of the function for which the component is described. In some aspects, the components may be physical or virtual devices.

Example system 800 includes at least one processing unit (CPU or processor) 810 and connection 805 that communicatively couples various system components including system memory 815, such as read-only memory (ROM) 820 and random access memory (RAM) 825 to processor 810. Computing system 800 may include a cache 812 of high-speed memory connected directly with, in close proximity to, or integrated as part of processor 810.

Processor 810 may include any general purpose processor and a hardware service or software service, such as services 832, 834, and 836 stored in storage device 830, configured to control processor 810 as well as a special-purpose processor where software instructions are incorporated into the actual processor design. Processor 810 may essentially be a completely self-contained computing system, containing multiple cores or processors, a bus, memory controller, cache, etc. A multi-core processor may be symmetric or asymmetric.

To enable user interaction, computing system 800 includes an input device 845, which may represent any number of input mechanisms, such as a microphone for speech, a touch-sensitive screen for gesture or graphical input, keyboard, mouse, motion input, speech, etc. Computing system 800 may also include output device 835, which may be one or more of a number of output mechanisms. In some instances, multimodal systems may enable a user to provide multiple types of input/output to communicate with computing system 800.

Computing system 800 may include communications interface 840, which may generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 840 may also include one or more Global Navigation Satellite System (GNSS) receivers or transceivers that are used to determine a location of the computing system 800 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 830 may be a non-volatile and/or non-transitory and/or computer-readable memory device and may be a hard disk or other types of computer readable media which may store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 830 may include software services, servers, services, etc., that when the code that defines such software is executed by the processor 810, it causes the system to perform a function. In some aspects, a hardware service that performs a particular function may include the software component stored in a computer-readable medium in connection with the necessary hardware components, such as processor 810, connection 805, output device 835, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data may be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects may be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination may correspond to a return of the function to the calling function or the main function.

Processes and methods according to the above-described examples may be implemented using computer-executable instructions that are stored or otherwise available from computer-readable media. Such instructions may include, for example, instructions and data which cause or otherwise configure a general purpose computer, special purpose computer, or a processing device to perform a certain function or group of functions. Portions of computer resources used may be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects the computer-readable storage devices, mediums, and memories may include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and may take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also may be embodied in peripherals or add-in cards. Such functionality may also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that may be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein may be replaced with less than or equal to (“≤”) and greater than or equal to (“≥”) symbols, respectively, without departing from the scope of this description.

Where components are described as being “configured to” perform certain operations, such configuration may be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B.

Illustrative aspects of the disclosure include:

Aspect 1: An apparatus including at least one memory, and at least one processor coupled to the at least one memory and configured to: receive, from a plurality of sensors of a vehicle, sensor data representative of an environment; process the sensor data from the plurality of sensors using a plurality of encoders to generate a plurality of outputs; generate, based on the plurality of outputs of the plurality of encoders, a plurality of world model tokens representing a unified scene representation of the environment; and decode the plurality of world model tokens using a plurality of perception decoders for performing at least one task.

Aspect 2: The apparatus of Aspect 1, wherein the plurality of outputs of the plurality of encoders comprises spatial grid features, sparse tokens, and learned embeddings.

Aspect 3: The apparatus of Aspect 1 or 2, wherein the plurality of sensors includes at least one camera sensor, at least one light detection and ranging (LIDAR) sensor, and at least one radio detection and ranging (RADAR) sensor.

Aspect 4: The apparatus of any of Aspects 1 to 3, wherein the plurality of sensors includes at least one odometry sensor.

Aspect 5: The apparatus of any of Aspects 1 to 4, wherein the sensor data includes a plurality of images from the at least one camera sensor, a plurality of RADAR feature maps from the at least one RADAR sensor, and a plurality of LIDAR-based feature maps from the at least one LIDAR sensor.

Aspect 6: The apparatus of any of Aspects 1 to 5, wherein the sensor data further includes HD-map features and odometry data.

Aspect 7: The apparatus of any of Aspects 1 to 6, wherein the plurality of outputs of the plurality of encoders comprises at least one of bird's eye view (BEV) embeddings, HD map tokens, or odometry tokens.

Aspect 8: The apparatus of any of Aspects 1 to 7, wherein the at least one processor is configured to decode, using a plurality of perception decoders, the plurality of world model tokens to generate at least one of an output corresponding to plurality of static objects, an output corresponding to a plurality of dynamic objects, or occupancy graphs indicating occupancy in space based on at least one of static objects or dynamic objects.

Aspect 9: The apparatus of any of Aspects 1 to 8, wherein the at least one processor is configured to: generate, based on processing of the sensor data using the plurality of encoders, a unified embedding; and provide the unified embedding as input to a transformer aggregator.

Aspect 10: The apparatus of Aspect 9, wherein, to generate the unified embedding, the at least one processor is configured to concatenate embeddings based on sensor data corresponding to each sensor of the plurality of sensors.

Aspect 11: The apparatus of any of Aspects 1 to 10, wherein the at least one task comprises at least one of lane detection, lane mapping, static object detection, dynamic object detection, occupancy estimation, or attribute classification tasks.

Aspect 12: A method including: receiving, from a plurality of sensors of a vehicle, sensor data representative of an environment; processing the sensor data from the plurality of sensors using a plurality of encoders to generate a plurality of outputs; generating, based on the plurality of outputs of the plurality of encoders, a plurality of world model tokens representing a unified scene representation of the environment; and decoding the plurality of world model tokens using a plurality of perception decoders for performing at least one task.

Aspect 13: The method of Aspect 12, wherein the plurality of outputs of the plurality of encoders comprises spatial grid features, sparse tokens, and learned embeddings.

Aspect 14: The method of Aspect 12 or 13, wherein the plurality of sensors includes at least one camera sensor, at least one light detection and ranging (LIDAR) sensor, and at least one radio detection and ranging (RADAR) sensor.

Aspect 15: The method of any of Aspects 12 to 14, wherein the plurality of sensors includes at least one odometry sensor.

Aspect 16: The method of any of Aspects 12 to 15, wherein the sensor data includes a plurality of images from the at least one camera sensor, a plurality of RADAR feature maps from the at least one RADAR sensor, and a plurality of LIDAR-based feature maps from the at least one LIDAR sensor.

Aspect 17: The method of any of Aspects 12 to 16, wherein the sensor data further includes HD-map features and odometry data.

Aspect 18: The method of any of Aspects 12 to 17, wherein the plurality of outputs of the plurality of encoders comprises at least one of bird's eye view (BEV) embeddings, HD map tokens, or odometry tokens.

Aspect 19: The method of any of Aspects 12 to 18, further comprising decoding, using a plurality of perception decoders, the plurality of world model tokens to generate at least one of an output corresponding to plurality of static objects, an output corresponding to a plurality of dynamic objects, or occupancy graphs indicating occupancy in space based on at least one of static objects or dynamic objects.

Aspect 20: The method of any of Aspects 12 to 19, further comprising: generating, based on processing of the sensor data using the plurality of encoders, a unified embedding; and providing the unified embedding as input to a transformer aggregator.

Aspect 21: The method of Aspect 20, wherein generating the unified embedding comprises concatenating embeddings based on sensor data corresponding to each sensor of the plurality of sensors.

Aspect 22: The method of any of Aspects 12 to 21, wherein the at least one task comprises at least one of lane detection, lane mapping, static object detection, dynamic object detection, occupancy estimation, or attribute classification tasks.

Aspect 23: A non-transitory computer-readable medium having stored thereon instructions that, when executed by at least one processor, cause the at least one processor to perform operations according to any of Aspects 12 to 22.

Aspect 24: An apparatus including one or more means for performing operations according to any of Aspects 12 to 22.

The previous description of the disclosed aspects is provided to enable a person skilled in the art to make or use the disclosed aspects. Various modifications to these aspects will be readily apparent to those skilled in the art, and the principles defined herein may be applied to other aspects without departing from the scope of the disclosure. Thus, the present disclosure is not intended to be limited to the aspects shown herein but is to be accorded the widest scope possible consistent with the principles and novel features as defined by the following claims.

What is claimed is:

1. An apparatus for processing sensor data, comprising:
at least one memory; and
at least one processor coupled to the at least one memory and configured to:
receive, from a plurality of sensors of a vehicle, sensor data representative of an environment;
process the sensor data from the plurality of sensors using a plurality of encoders to generate a plurality of outputs;
generate, based on the plurality of outputs of the plurality of encoders, a plurality of world model tokens representing a unified scene representation of the environment; and
decode the plurality of world model tokens using a plurality of perception decoders for performing at least one task.

2. The apparatus of claim 1, wherein the plurality of outputs of the plurality of encoders comprises spatial grid features, sparse tokens, and learned embeddings.

3. The apparatus of claim 1, wherein the plurality of sensors includes at least one camera sensor, at least one light detection and ranging (LIDAR) sensor, and at least one radio detection and ranging (RADAR) sensor.

4. The apparatus of claim 3, wherein the plurality of sensors further includes at least one odometry sensor.

5. The apparatus of claim 3, wherein the sensor data includes a plurality of images from the at least one camera sensor, a plurality of RADAR feature maps from the at least one RADAR sensor, and a plurality of LIDAR-based feature maps from the at least one LIDAR sensor.

6. The apparatus of claim 5, wherein the sensor data further includes HD-map features and odometry data.

7. The apparatus of claim 1, wherein the plurality of outputs of the plurality of encoders comprises at least one of bird's eye view (BEV) embeddings, HD map tokens, or odometry tokens.

8. The apparatus of claim 1, wherein the at least one processor is configured to decode, using a plurality of perception decoders, the plurality of world model tokens to generate at least one of an output corresponding to plurality of static objects, an output corresponding to a plurality of dynamic objects, or occupancy graphs indicating occupancy in space based on at least one of static objects or dynamic objects.

9. The apparatus of claim 1, wherein the at least one processor is configured to:
generate, based on processing of the sensor data using the plurality of encoders, a unified embedding; and
provide the unified embedding as input to a transformer aggregator.

10. The apparatus of claim 9, wherein, to generate the unified embedding, the at least one processor is configured to concatenate embeddings based on sensor data corresponding to each sensor of the plurality of sensors.

11. The apparatus of claim 1, wherein the at least one task comprises at least one of lane detection, lane mapping, static object detection, dynamic object detection, occupancy estimation, or attribute classification tasks.

12. A method of processing sensor data comprising:
receiving, from a plurality of sensors of a vehicle, sensor data representative of an environment;
processing the sensor data from the plurality of sensors using a plurality of encoders to generate a plurality of outputs;
generating, based on the plurality of outputs of the plurality of encoders, a plurality of world model tokens representing a unified scene representation of the environment; and
decoding the plurality of world model tokens using a plurality of perception decoders for performing at least one task.

13. The method of claim 12, wherein the plurality of outputs of the plurality of encoders comprises spatial grid features, sparse tokens, and learned embeddings.

14. The method of claim 12, wherein the plurality of sensors includes at least one camera sensor, at least one light detection and ranging (LIDAR) sensor, at least one radio detection and ranging (RADAR) sensor, and at least one odometry sensor.

15. The method of claim 14, wherein the plurality of sensors further includes at least one odometry sensor.

16. The method of claim 14, wherein the sensor data includes a plurality of images from the at least one camera sensor, a plurality of RADAR feature maps from the at least one RADAR sensor, and a plurality of LIDAR-based feature maps from the at least one LIDAR sensor.

17. The method of claim 16, wherein the sensor data further includes HD-map features and odometry data.

18. The method of claim 12, wherein the plurality of outputs of the plurality of encoders comprises at least one of bird's eye view (BEV) embeddings, HD map tokens, or odometry tokens.

19. The method of claim 12, further comprising decoding, using a plurality of perception decoders, the plurality of world model tokens to generate at least one of an output corresponding to plurality of static objects, an output corresponding to a plurality of dynamic objects, or occupancy graphs indicating occupancy in space based on at least one of static objects or dynamic objects.

20. The method of claim 12, further comprising:
generating, based on processing of the sensor data using the plurality of encoders, a unified embedding; and
providing the unified embedding as input to a transformer aggregator.
